(19) United States
(12) Patent Application Publication
(10) Pub. No.: US 2024/0112195 A1
(43) Pub. Date: Apr. 4, 2024

(54) Identifying and Resolving Consumer Transactions Using Consumer Call Analytics

(71) Applicant: Bank of America Corporation, Charlotte, NC (US)

(72) Inventors: Sam William Christian, Telangana (IN); Samuel Massa Moiyallah, JR., Newark, DE (US)

(21) Appl. No.: 17/954,537

(22) Filed: Sep. 28, 2022

(51) Int. Cl. G06Q 30/00

(52) U.S. Cl. CPC G06Q 30/016

(57) ABSTRACT

Aspects of the disclosure relate to identifying and resolving consumer transactions using consumer call analytics. The computing platform may monitor consumer transactions and score each detected transaction. The computing platform may predict, using the score associated with the transaction, whether the consumer may request assistance with the transaction. The computing platform may receive, from the consumer, a request for assistance with at least one transaction. The computing platform may use a unique consumer identifier to identify transactions associated with the consumer. The computing platform may determine whether at least one similar consumer request for assistance was previously received. If at least one similar consumer request for assistance was previously received, the computing platform may retrieve the previously received request and a corresponding solution. Alternatively, a similar consumer request for assistance was not previously received, the computing platform may generate a solution to the consumer request.

### BACKGROUND

Aspects of the disclosure relate to hardware and software for identifying and resolving consumer transactions using consumer call analytics. In particular, one or more aspects of the disclosure relate to predicting whether a request for assistance will be received, receiving a request for assistance, identifying one or more solutions to the received request for assistance, and transmitting the solutions based on training a machine learning model to analyze enterprise organization programs and/or services that may resolve an issue.

Current consumer services allow consumers to speak with an enterprise organization agent to request assistance with the services and/or products offered by the enterprise organization. In doing so, the consumer remains on the call until an available agent is able to assist the consumer. When the consumer reaches an available agent, the consumer may be asked to remain on the call while the agent gathers details about the issue the consumer faced, locates a file associated with the consumer, analyzes the consumer's history (e.g., transaction history, assistance request history, or the like), and/or proposes a response to the consumer call requesting transaction assistance. The total amount of time that the consumer may remain on the call (e.g., to reach an available agent, to receive a response to the consumer call, or the like) may differ depending on the volume of calls that the enterprise organization receives.

Furthermore, when reviewing the consumer's file and history, the agent might not be permitted to compare the consumer's file and history to other consumers associated with the enterprise organization. The representative might not be permitted to access previous consumer calls requesting transaction assistance that may be similar to the present consumer call. As such, the representative might not be able to track the number of similar consumer calls and/or propose an enterprise organization wide solution to the similar consumer calls. The representative might not be able to monitor each of the consumer's transactions with the enterprise organization and/or predict the transaction with which the consumer may request assistance. Therefore, current consumer services do not permit consumers to terminate the call with the enterprise organization and receive a call back from the enterprise organization with a proposed response to the request for assistance and do not permit enterprise organizations to continuously monitor consumer transactions, to predict the transaction with which the consumer may request assistance, and/or to provide at least one response to the consumer call based on previously analyzed consumer calls.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, and convenient technical solutions that address and overcome the technical problems associated with identifying and resolving, in real-time or near real-time, transactions using call analytics.

In accordance with one or more embodiments, a method may comprise, at a computing device including one or more processors and memory, detecting a plurality of transactions between a consumer computing device and an enterprise organization computing device. The method may comprise storing the plurality of transactions in a transaction history associated with the consumer computing device. The method may comprise assigning a score to each transaction of the plurality of transactions. The method may comprise receiving, from the consumer computing device, a consumer concern requesting assistance with a transaction. The method may comprise receiving, from the enterprise organization computing device, a token comprising details that describe the consumer concern and the consumer computing device. The method may comprise determining whether the consumer concern corresponds to at least one transaction within the transaction history associated with the consumer computing device. The method may comprise, based on determining the consumer concern corresponds to at least one transaction within the transaction history, determining whether the transaction is similar to at least one previously received transaction. The method may comprise, based on determining the transaction is different from previously received transactions, generating a solution to the consumer concern. The method may comprise transmitting, to the enterprise organization computing device, instructions to initiate communication with the consumer computing device to resolve the consumer concern.

In accordance with one or more embodiments, a computing platform may comprise at least one processor, a communication interface communicatively coupled to the at least one processor, and memory storing computer-readable instructions that, when executed by the at least one processor, cause the computing platform to detect a plurality of transactions between a consumer computing device and an enterprise organization computing device. The computing platform may store the plurality of transactions in a transaction history associated with the consumer computing device. The computing platform may assign a score to each transaction of the plurality of transactions. The computing platform may receive, from the consumer computing device, a consumer concern requesting assistance with a transaction. The computing platform may receive, from the enterprise organization computing device, a token comprising details that describe the consumer concern and the consumer computing device. The computing platform may determine whether the consumer concern corresponds to at least one transaction within the transaction history associated with the consumer computing device. The computing platform may, based on determining the consumer concern corresponds to at least one transaction within the transaction history, determine whether the transaction is similar to at least one previously received transaction. The computing platform may, based on determining the transaction is different from previously received transactions, generate a solution to the consumer concern. The computing platform may transmit, to the enterprise organization computing device, instructions to initiate communication with the consumer computing device to resolve the consumer concern.

In accordance with one or more embodiments, one or more non-transitory computer-readable media storing instructions that, when executed by a computing platform comprising at least one processor, memory, and a communication interface, cause the computing platform to detect a plurality of transactions between a consumer computing device and an enterprise organization computing device. The instructions, when executed, may cause the computing platform to store the plurality of transactions in a transaction history associated with the consumer computing device. The instructions, when executed, may cause the computing platform to assign a score to each transaction of the plurality of transactions. The instructions, when executed, may cause the computing platform to receive, from the consumer computing device, a consumer concern requesting assistance with a transaction. The instructions, when executed, may cause the computing platform to receive, from the enterprise organization computing device, a token comprising details that describe the consumer concern and the consumer computing device. The instructions, when executed, may cause the computing platform to determine whether the consumer concern corresponds to at least one transaction within the transaction history associated with the consumer computing device. The instructions, when executed, may cause the computing platform to, based on determining the consumer concern corresponds to at least one transaction within the transaction history, determine whether the transaction is similar to at least one previously received transaction. The instructions, when executed, may cause the computing platform to, based on determining the transaction is different from previously received transactions, generate a solution to the consumer concern. The instructions, when executed, may cause the computing platform to transmit, to the enterprise organization computing device, instructions to initiate communication with the consumer computing device to resolve the consumer concern

These features, along with many others, are discussed in greater detail below.

### BRIEF DESCRIPTION OF THE DRAWINGS

The present disclosure is illustrated by way of example and is not limited in the accompanying figures in which like reference numerals indicate similar elements and in which:

FIG. 1A depicts an illustrative example of a computer system for generating transaction recommendations based on monitoring and analyzing consumer transactions, in accordance with one or more example embodiments.

FIG. 1B depicts an illustrative example of the computing platform that may be used for generating transaction recommendations based on monitoring and analyzing consumer transactions, in accordance with one or more example embodiments.

FIG. 2A-2J depict an illustrative event sequence for identifying and resolving consumer transactions using consumer call analytics, in accordance with one or more example embodiments.

FIGS. 3A-3E depict an illustrative event sequence for generating transaction recommendations based on monitoring and analyzing consumer transactions, in accordance with one or more example embodiments.

FIG. 4 depicts an illustrative method for identifying and resolving consumer transactions using consumer call analytics, in accordance with one or more example embodiments.

FIG. 5 depicts an illustrative method for generating transaction recommendations based on monitoring and analyzing consumer transactions, in accordance with one or more example embodiments.

### DETAILED DESCRIPTION

In the following description of various illustrative embodiments, reference is made to the accompanying drawings, which form a part hereof, and in which are shown, by way of illustration, various embodiments in which aspects of the disclosure may be practiced. It is to be understood that other embodiments may be utilized, and structural and functional modifications may be made, without departing from the scope of the present disclosure. Various aspects are capable of other embodiments and of being practiced or being carried out in various different ways.

It is noted that various connections between elements are discussed in the following description. It is noted that these connections are general and, unless specified otherwise, may be direct or indirect, wired or wireless, and that the specification is not intended to be limiting in this respect.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

As discussed above, current consumer services recommendation protocols do not permit enterprise organizations to monitor a consumer's transaction history and preemptively generate solutions (e.g., enterprise organization wide solutions, solutions tailored to the consumer, or the like) based on at least one transactional issue identified in the transaction history. Accordingly, proposed herein is a solution to the problem described above that includes generating transaction recommendations based on monitoring and analyzing consumer transactions. For example, a computing platform may continuously monitor consumer transactions (e.g., with appropriate permissions from the user) and may continuously monitor a transaction history associated with a consumer computing device (e.g., with appropriate permissions from the user). The computing platform may analyze the transaction history associated with the consumer computing device to determine whether the consumer computing device previously experienced transactional issues. The computing platform may identify at least one transactional issue and may categorize the at least one transactional issue. The computing platform may identify, based on the categorization, at least one enterprise organization team and/or department associated with the at least one transactional issue and may transmit the at least one transactional issue to the associated enterprise organization team and/or department for further analysis. The computing platform may determine whether at least one existing enterprise organization program and/or service addresses the at least one transactional issue. Based on determining the at least one enterprise organization program addresses the at least one transactional issue, the computing platform may analyze informational and/or instructional materials associated with the at least one enterprise organization program to determine whether the informational and/or instructional materials offers at least one solution to the at least one transactional issue. The computing platform may transmit the at least one enterprise organization program to the consumer computing device to resolve the at least one transactional issue.

Computer Architecture

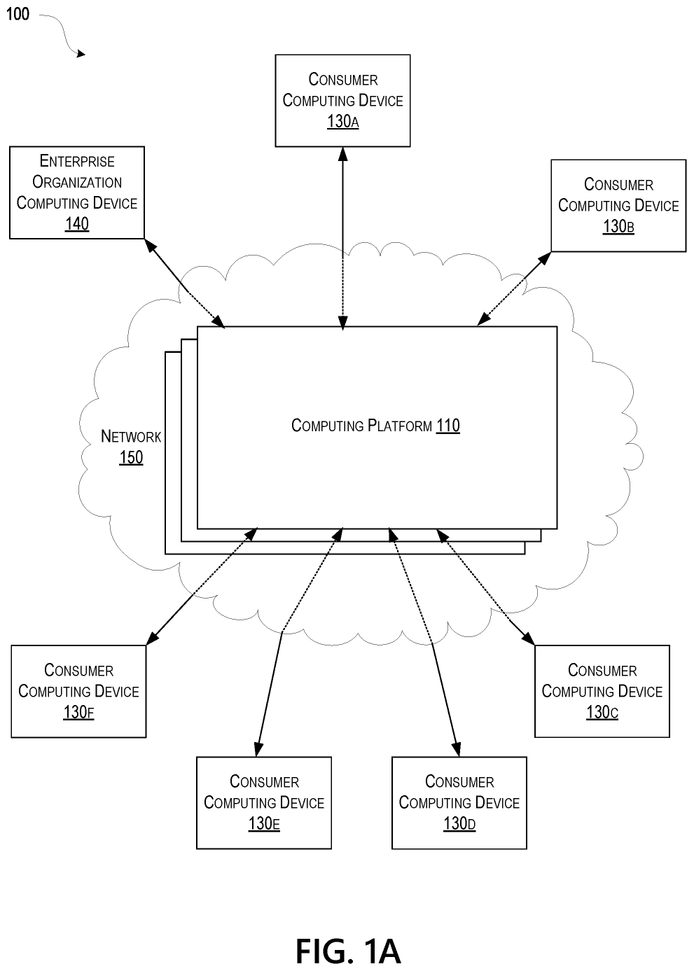

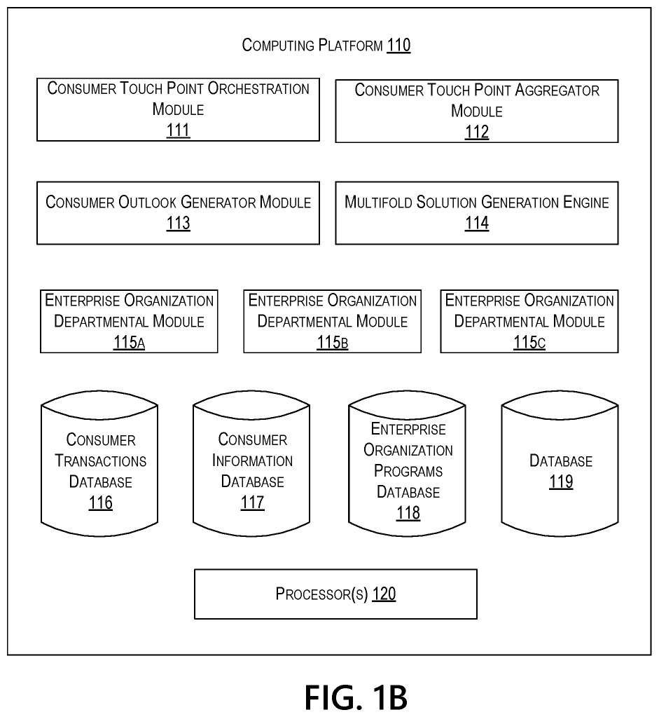

FIG. 1A depicts an illustrative example of a computer system 100 that may be used for generating, in real-time or near real-time, transaction recommendations based on monitoring and analyzing consumer transactions, in accordance with one or more aspects described herein. Computer system 100 may comprise one or more computing devices including at least computing platform 110, consumer computing devices 130a-130f, and enterprise organization computing device 140. While FIG. 1A depicts more than one consumer computing devices (e.g., consumer computing devices 130a-130f), each of consumer computing devices 130a-130f may be configured in accordance with the features described herein. While the description herein may refer to consumer computing device 130, it is important to note that the functions described in connection with consumer computing device 130 may also be performed by any one of consumer computing devices 130a-130f. While FIG. 1A depicts consumer computing devices 130a-130f, more or less than six consumer computing devices may exist within computer system 100. Six consumer computing devices are depicted in FIG. 1A for illustration purposes only and are not meant to be limiting.

Consumer computing device 130 may interact with (e.g., initiate consumer transactions with, execute consumer transaction with, or the like) enterprise organization computing device 140. In some instances, consumer computing device 130 may experience at least one transactional issue and may generate a consumer concern to describe the at least one transactional issue. Consumer computing device 130 may transmit the consumer concern to enterprise organization computing device 140 and may receive, from enterprise organization computing device 140, a notification indicating that the consumer concern might not be processed or indicating at least one solution to the at least one transactional issue indicated in the consumer concern.

While FIG. 1A depicts one enterprise organization computing device (e.g., enterprise organization computing device 140), more than one enterprise organization computing device may exist within computer system 100. Enterprise organization computing device 140 is depicted in FIG. 1A for illustration purposes only and is not meant to be limiting. Enterprise organization computing device 140 may be configured to receive the consumer concern from consumer computing device 130 and to determine whether consumer computing device 130 is associated with the enterprise organization (e.g., whether consumer computing device 130 is associated with a unique consumer identifier that may be registered with the enterprise organization, whether consumer computing device 130 is associated with a phone number that may be registered with the enterprise organization, or the like). Enterprise organization computing device 140 may initiate communication with consumer computing device 130 to transmit at least one solution to the at least one transactional issue that consumer computing device 130 may have experienced.

Each one of consumer computing devices 130a-130f and enterprise organization computing device 140 may be configured to communicate with computing platform 110 through network 150. In some arrangements, computer system 100 may include additional computing devices and networks that are not depicted in FIG. 1A, which may also be configured to interact with computing platform 110.

Computing platform 110 may be associated with a distinct entity such as an enterprise organization, company, school, government, and the like, and may comprise one or more personal computer(s), server computer(s), hand-held or laptop device(s), multiprocessor system(s), microprocessor-based system(s), set top box(es), programmable user electronic device(s), network personal computer(s) (PC), minicomputer(s), mainframe computer(s), distributed computing environment(s), and the like. Computing platform 110 may include computing hardware and software that may host various data and applications for performing tasks of the centralized entity and interacting with consumer computing device 130, enterprise organization computing device 140, and/or additional computing devices. Computing platform 110 may receive, from at least one of consumer computing devices 130a-130f, a consumer concern indicating a request for assistance with at least one transactional issue. In some instances, computing platform may analyze (e.g., with permission from a user, or the like) a consumer history associated with consumer computing device 130 to identify, without receiving a request for assistance, the at least one transactional issue with which consumer computing device 130 may require assistance. Computing platform 110 may generate, based on analyzing the at least one transactional issue and a plurality of enterprise organization programs and/or services, at least one solution to the at least one transactional issue. Computing platform 110 may instruct enterprise organization computing device 140 to initiate communication with at least one of consumer computing devices 130a-130f to transmit the at least one solution.

In some arrangements, computing platform 110 may include and/or be part of enterprise information technology infrastructure and may host a plurality of enterprise applications, enterprise databases, and/or other enterprise resources. Such applications may be executed on one or more computing devices included in computing platform 110 using distributed computing technology and/or the like. In some instances, computing platform 110 may include a relatively large number of servers that may support operations of the enterprise organization, such as a financial institution. Computing platform 110, in this embodiment, may generate a single centralized ledger, which may be stored in database 119, for data received from at least one of consumer computing device 130 and/or enterprise organization computing device 140.

Consumer computing device 130 and/or enterprise organization computing device 140 may be configured to interact with computing platform 110 through network 150. In some instances, at least one of consumer computing device 130 and/or enterprise organization computing device 140 may be configured to receive and transmit information corresponding to consumer requests through particular channels and/or applications associated with computing platform 110. The requests submitted by at least one of consumer computing device 130 and/or enterprise organization computing device 140 may initiate the performance of particular computational functions at computing platform 110, such as the analysis of at least one consumer concern.

As stated above, computer system 100 also may include one or more networks, which may interconnect one or more of computing platform 110, consumer computing device 130, and enterprise organization computing device 140. For example, centralized computer system 100 may include network 150. Network 150 may include one or more sub-networks (e.g., local area networks (LANs), wide area networks (WANs), or the like). Furthermore, computer system 100 may include a local network configured to interconnect each of the computing devices comprising computing platform 110.

FIG. 1B depicts the components of computing platform 110 that may be used for generating, in real-time or near real-time, transaction recommendations based on monitoring and analyzing consumer transactions, in accordance with one or more aspects described herein. Computing platform 110 may use consumer touch point orchestration module 111, consumer touch point aggregator module 112, consumer outlook generator module 113, multifold solution generation engine 114, enterprise organization departmental modules 115a-115c, consumer transactions database 116, consumer information database 117, enterprise organization programs database 118, database 119, and/or processor(s) 120 to analyze at least one consumer concern (e.g., at least one consumer request for assistance, or the like). Each computing device within computing platform 110 may contain database 119 and processor(s) 120, which may be stored in memory of the one or more computing devices of computing platform 110. Through execution of computer-readable instructions stored in memory, the computing devices of computing platform 110 may be configured to perform functions of the centralized entity and store the data generated during the performance of such functions in database 119.

Consumer touch point orchestration module 111 may detect a plurality of transactions between consumer computing device 130 and enterprise organization computing device 140. Consumer touch point orchestration module 111 may assign a score to each detected transaction and may predict, based on the score, whether consumer computing device 130 may request assistance with the transaction. Consumer touch point orchestration module 111 may parse consumer transactions database 116 and/or consumer information database 117 to identify at least one transactional issue that consumer computing device 130 may have experienced and about which consumer computing device 130 may have generated a consumer concern.

Consumer touch point aggregator module 112 may categorize each transaction detected by consumer touch point orchestration module 111. For instance, consumer touch point aggregator module 112 may store instructions or data that may cause the computing platform 110 to parse each detected transaction to identify a service that corresponds to the transaction (e.g., denial of service, account withdrawal, or the like). Consumer touch point aggregator module 112 may group the detected transactions based on the corresponding services and store each group.

Consumer outlook generator module 113 may parse at least one solution to the at least one transactional issue that consumer computing device 130 may have experienced. Consumer outlook generator module 111 may determine, based on the parsing, whether an enterprise organization agent may be needed to transmit the at least one solution to consumer computing device 130 and/or to resolve the consumer concern.

Multifold solution generation engine 114 may identify, based on receiving the categorizations from consumer touch point aggregator module 112, at least one of enterprise organization departmental modules 115a-115c that may offer an enterprise organization program and/or service with which consumer computing device 130 may have experienced the at least one transactional issue indicated in the consumer concern. Multifold solution generation engine 114 may analyze a count associated with the at least one transactional issue and generate, based on the analysis, at least one enterprise organization wide solution or at least one solution tailored to consumer computing device 130.

While FIG. 1B depicts enterprise organization departmental modules 115a-115c, more or less than three enterprise organization departmental modules may exist within computer system 100. Enterprise organization departmental modules 115a-115c are depicted in FIG. 1B for illustration purposes only and are not meant to be limiting. Each of enterprise organization departmental modules 115a-115c may be configured in accordance with the features described herein. While the description herein may refer to enterprise organization departmental module 115, the functions described in connection with enterprise organization departmental module 115 may also be performed by any one of enterprise organization departmental modules 115a-115c.

Enterprise organization departmental module 115 may analyze current enterprise organization procedures and/or protocols to determine whether to generate additional and/or modify existing procedures and/or protocols to address the at least one transactional issue indicated in the consumer concern. Enterprise organization departmental module 115 may determine whether at least one enterprise organization program and/or service may offer a solution to the at least one transactional issue (e.g., at least one enterprise organization program and/or service that may be different from the enterprise organization program and/or service with which consumer computing device 130 may have experienced the at least one transactional issue, or the like).

Identifying and Resolving Consumer Transactions Using Consumer Call Analytics

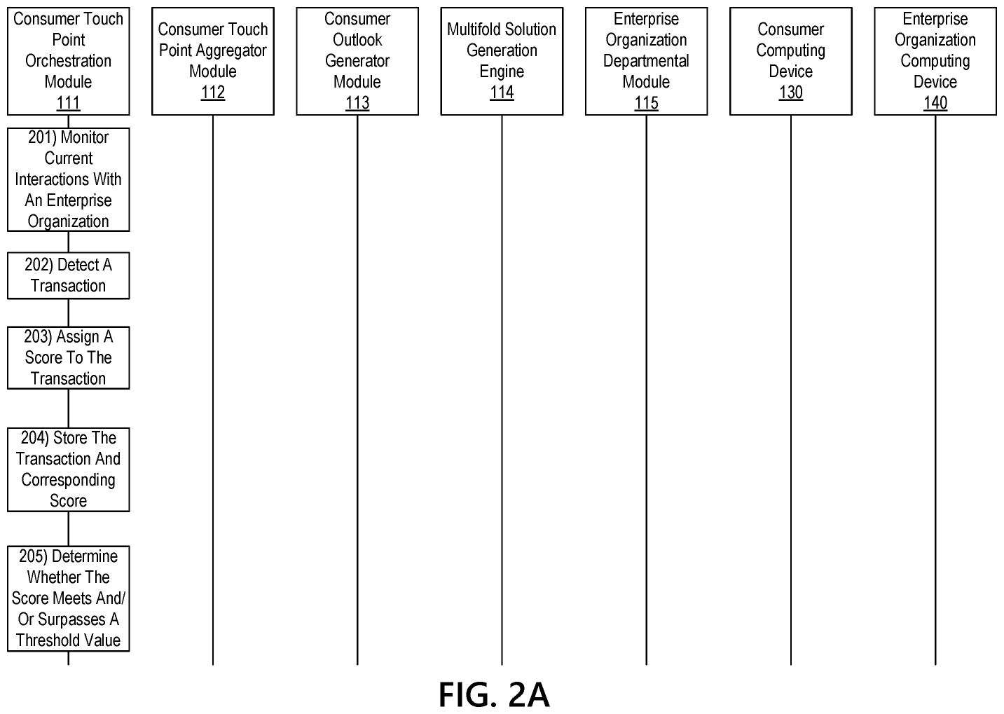

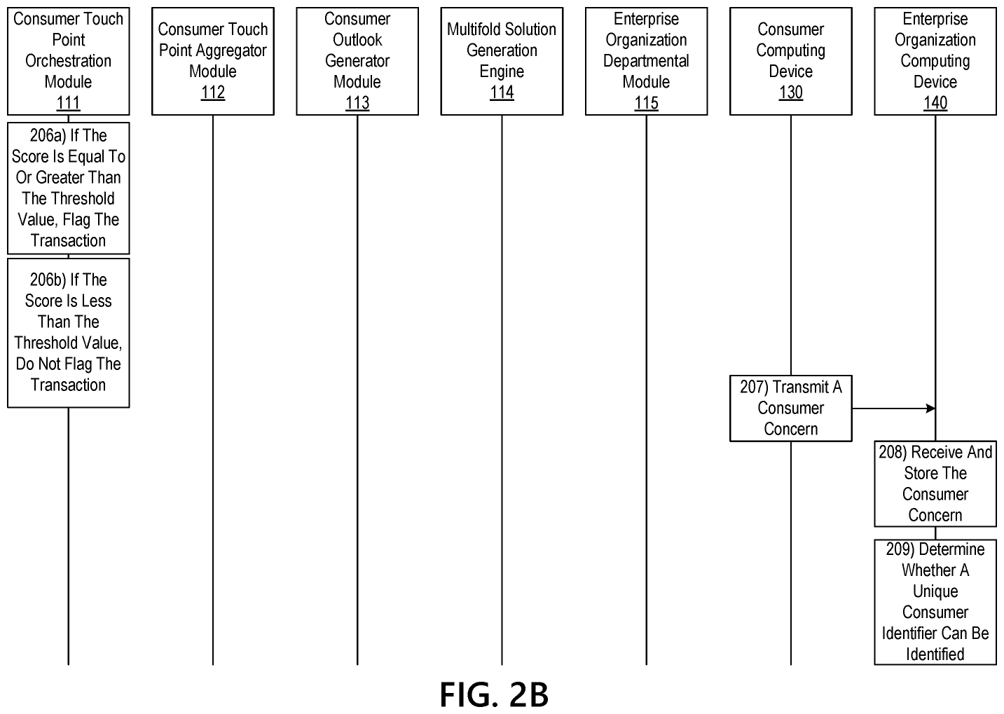

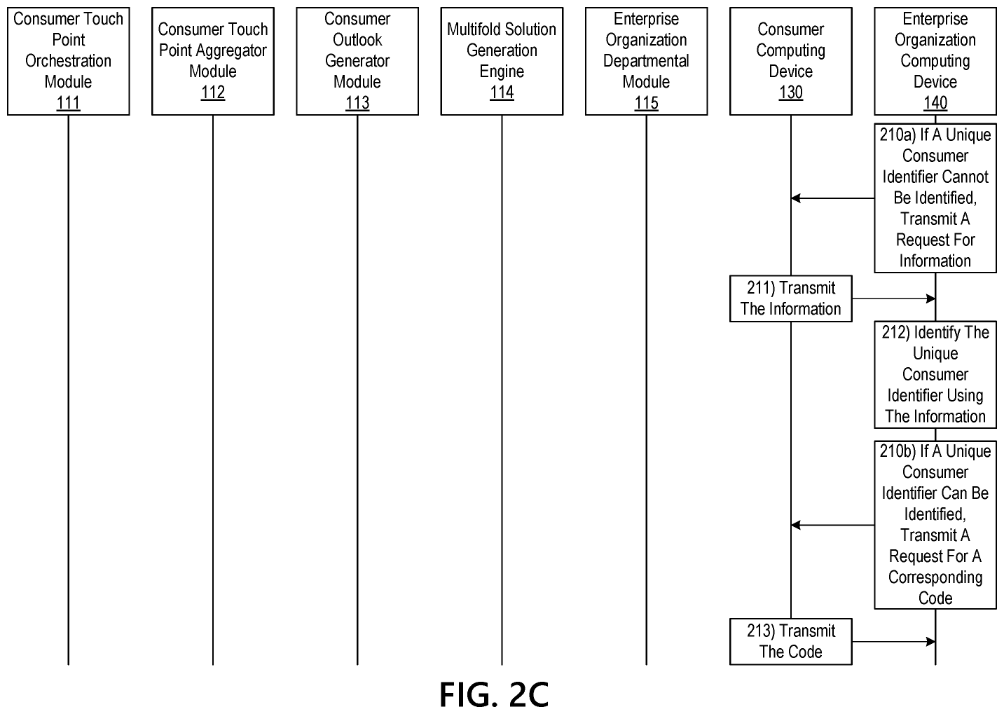

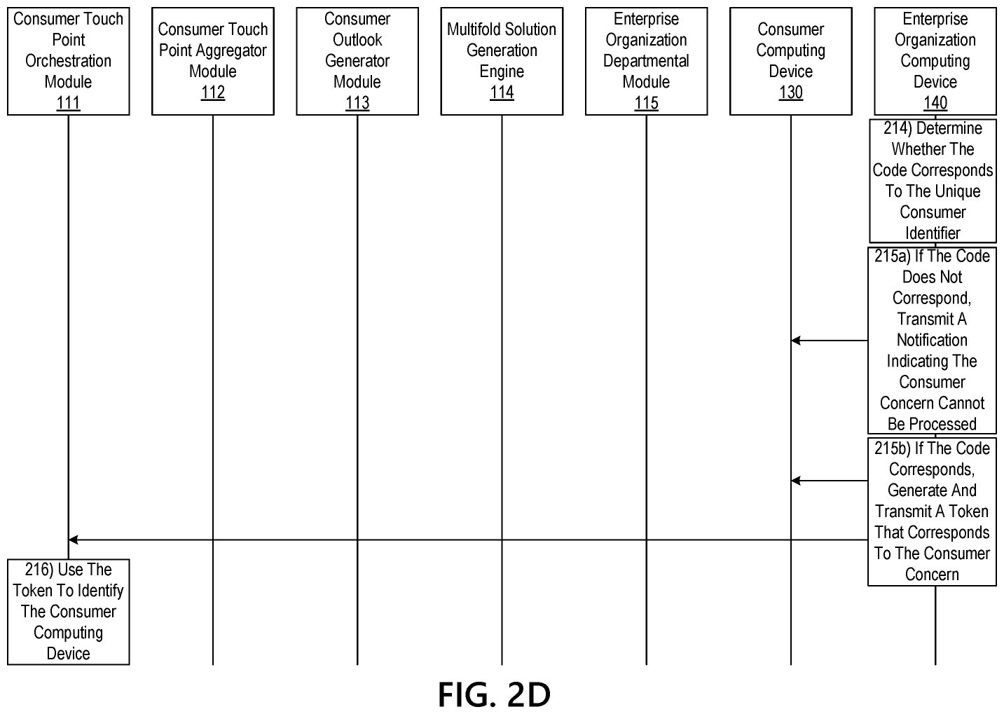

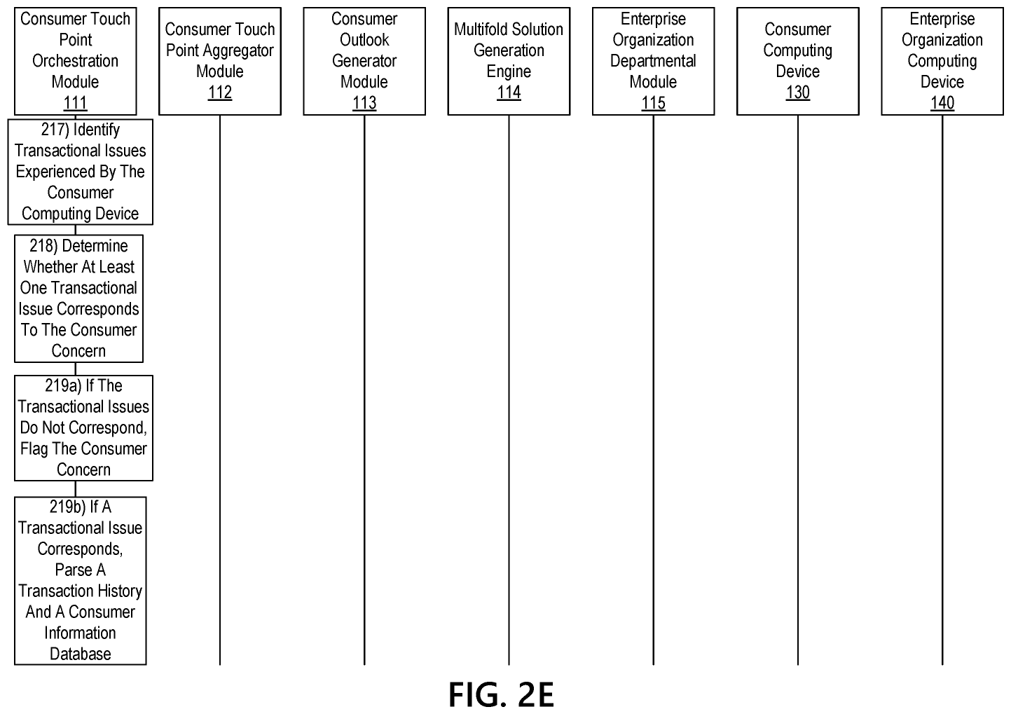

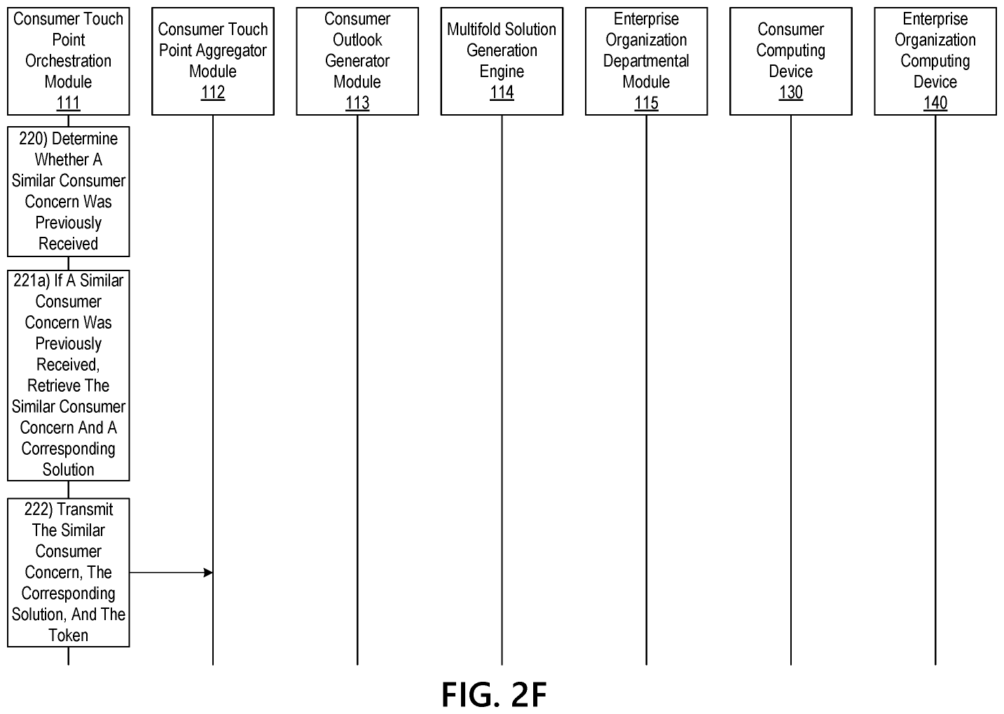

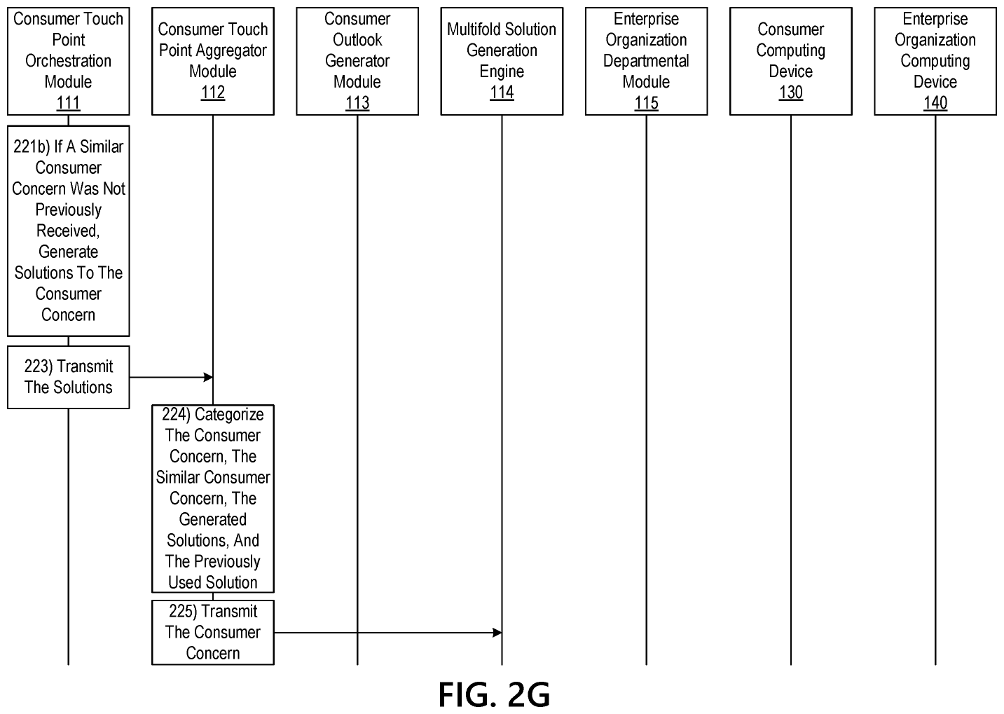

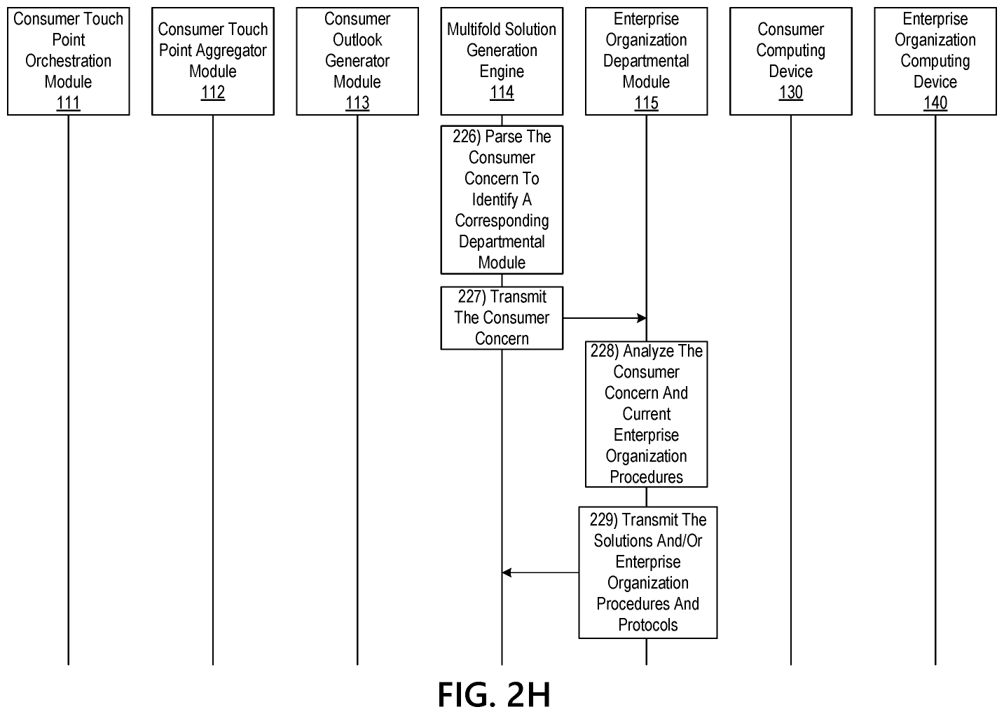

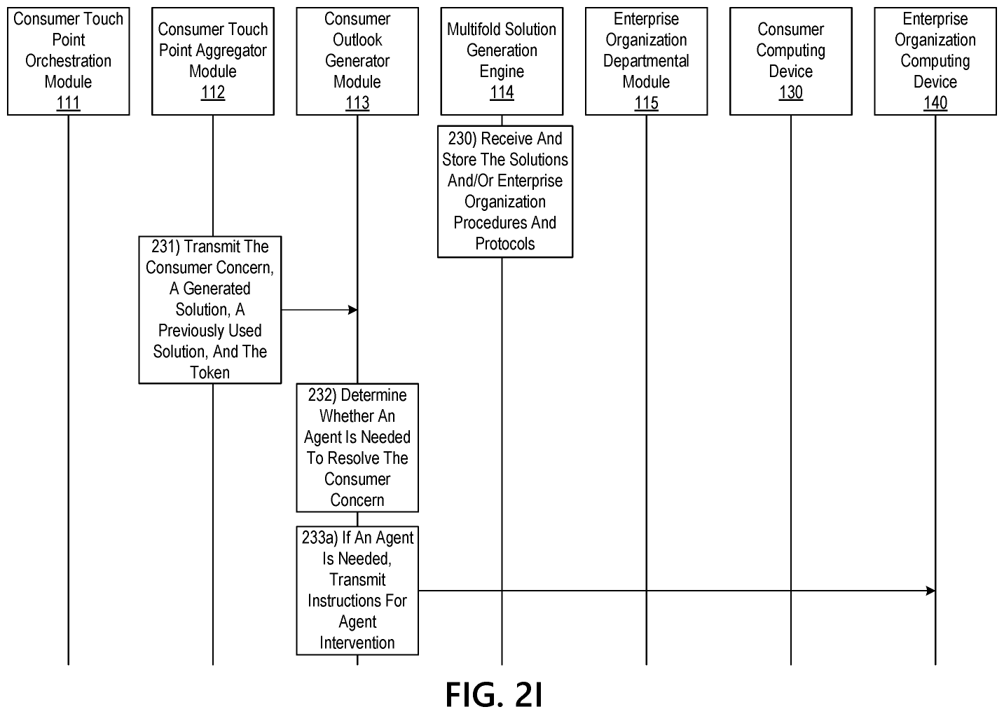

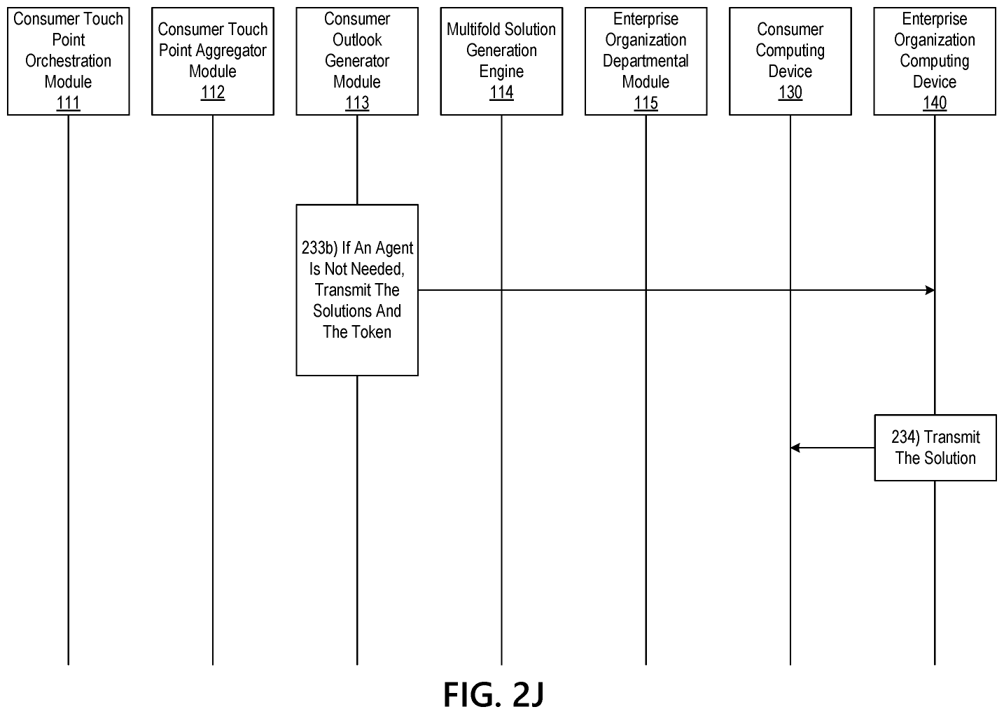

FIGS. 2A-2J depict an illustrative event sequence for identifying and resolving, in real-time or near real-time, consumer transactions using consumer call analytics, in accordance with one or more aspects described herein. While aspects described with respect to FIGS. 2A-2J include the evaluation of a single consumer concern (e.g., a single consumer request for assistance, or the like), a plurality consumer concerns may be received and evaluated (e.g., in parallel) without departing from the present disclosure. One or more process performed in FIGS. 2A-2J may be performed in real-time or near real-time and one or more steps or processes may be added, omitted, or performed in a different order, without departing from the invention.

Referring to FIG. 2A, at step 201, consumer touch point orchestration module 111 may monitor interactions (e.g., consumer transactions, consumer requests to initiate a transaction, or the like) between consumer computing device 130 and/or the enterprise organization (e.g., enterprise organization computing device 140, or the like). To do so, consumer touch point orchestration module 111 may log (e.g., in consumer transactions database 116, or the like) each transaction and/or request to initiate a transaction that enterprise organization computing device 140 may receive.

At step 202, consumer touch point orchestration module 111 may detect a consumer transaction. Consumer touch point orchestration module 111 may parse the consumer transaction to identify the consumer computing device (e.g., consumer computing device 130, or the like) associated with the transaction. In some instances, the transaction may be a direct transaction, wherein the direct transaction may comprise an interaction between consumer computing device 130 and enterprise organization computing device 140 (e.g., a withdrawal from an enterprise organization terminal, a deposit into an enterprise organization terminal, submission of a loan application, or the like). A direct transaction might not comprise an interaction with an external enterprise organization device (e.g., an automated teller machine (ATM), a point-of-sale terminal at a retail establishment, or the like). Additionally or alternatively, the transaction may be an indirect transaction, wherein the indirect transaction may comprise an interaction between consumer computing device 130 and an external enterprise organization device. Monitoring of consumer transactions may be performed with permission of the user (e.g., obtained during, for instance, a registration process in which the user may opt-in to the features described herein).

At step 203, consumer touch point orchestration module 111 may determine a score that corresponds to the transaction. The score may indicate the likelihood of consumer computing device 130 transmitting, to enterprise organization computing device 140, a consumer concern (e.g., a request for assistance with the transaction, or the like) indicating at least one transactional issue that consumer computing device 130 may have experienced. A score within a first level of likelihood (e.g., scores that may be greater than a threshold value, or the like) may indicate that consumer computing device 130 may transmit a consumer concern associated with the transaction. Alternatively, a score within a second level of likelihood (e.g., scores that may be less than the threshold value, or the like) may indicate that consumer computing device 130 might not transmit a consumer concern associated with the transaction. The threshold value may indicate a minimum level of likelihood at which consumer computing device 130 may transmit a consumer concern to enterprise organization computing device 140.

To generate the score for each transaction, consumer touch point orchestration module 111 may consider a plurality of factors (e.g., the transactional issue that consumer computing device 130 may have experienced, whether consumer computing device 130 may have previously experienced the transactional issue, whether the transactional issue may complicate additional enterprise organization services and/or programs in which consumer computing device 130 may be interested, or the like). Consumer touch point orchestration module 111 may assign a weight to each factor and may use the weighted factors to generate the score.

At step 204, consumer touch point orchestration module 111 may store the transaction and the corresponding score within consumer transactions database 116. Consumer transactions database 116 may comprise each transaction associated with each consumer computing device (e.g., consumer computing devices 130a-130f, or the like). Consumer transactions database 116 may sort each stored transaction based on the service and/or program to which each transaction may correspond (e.g., loan repayment programs, refinancing services, or the like). Consumer transactions database 116 may further comprise a description of each transaction (e.g., denial of service, institutional services availed, recent account activity, consumer life event, or the like). Consumer transactions database 116 may comprise data that may indicate at least one method through which each consumer computing device (e.g., consumer computing devices 130a-130f, or the like) may have previously received communication from enterprise organization computing device 140 (e.g., phone calls, SMS messaging, emails, social media messages and/or advertisements, or the like). Consumer transactions database 116 may further comprise, for each transaction, the score that corresponds to the transaction.

Access to consumer transactions database 116 may differ depending on the computing device that is requesting access (e.g., a hierarchy of accessibility). Consumer touch point orchestration module 111 and enterprise organization computing device 140 may be associated with a first level of accessibility (e.g., a least restrictive level of accessibility). Consumer touch point orchestration module 111 and enterprise organization computing device 140 may perform functions on the data stored within consumer transactions database 116 (e.g., access the transaction history associated with each consumer computing device, add transactions to each transaction history, remove transactions from each transaction history, modify transactions within each transaction history, or the like). The remaining computing devices within computing platform 110 may be associated with a second level of accessibility (e.g., a more restrictive level of accessibility than the first level of accessibility). The remaining computing devices within computing platform 110 may access the transaction history associated with each consumer computing device, but might not be permitted to add, remove, or modify the transaction histories within consumer transactions database 116.

At step 205, consumer touch point orchestration module 111 may determine whether the score that corresponds to each transaction is less than, equal to, or greater than the threshold value. If, at step 205, consumer touch point orchestration module 111 determines that the score that corresponds to a transaction is equal to or greater than the threshold value (e.g., within the first level of likelihood, or the like), then, referring to FIG. 2B and at step 206a, consumer touch point orchestration module 111 may flag the interaction (e.g., may indicate, in consumer transactions database 116, that consumer computing device 130 may transmit a consumer concern regarding the transaction, or the like). Alternatively, if, at step 205, consumer touch point orchestration module 111 determines that the score that corresponds to the transaction is less than the threshold value (e.g., within the second level of likelihood, or the like), then, at step 206b, consumer touch point orchestration module 111 might not flag the interaction (e.g., might not indicate, in consumer transactions database 116, that consumer computing device 130 may transmit a consumer concern regarding the transaction, or the like).

At step 207, consumer computing device 130 may generate a consumer concern to identify and/or explain at least one transactional issue (e.g., unable to complete a deposit, unable to submit a loan application, unable to register for a mortgage repayment service, or the like). Consumer computing device 130 may interact with an enterprise organization (e.g., a financial institution, or the like) and, by extension, may interact with a computing device associated with the enterprise organization (e.g., enterprise organization computing device 140). Consumer computing device 130 may initiate and/or execute a plurality of transactions with enterprise organization computing device 140. In some instances, consumer computing device 130 may successfully initiate and/or execute a transaction with enterprise organization computing device 140. However, in some instances, consumer computing device 130 may experience at least one transactional issue while initiating and/or executing a transaction. Consumer computing device 130 may generate the consumer concern to express the transactional issue to enterprise organization computing device 140 and/or to request assistance. Consumer computing device 130 may transmit the consumer concern to enterprise organization computing device 140 (e.g., may call enterprise organization computing device 140 via a telephone and may dictate the consumer concern, or the like).

At step 208, enterprise organization computing device 140 may receive the consumer concern from consumer computing device 130. Enterprise organization computing device 140 may store the consumer concern within consumer transactions database 116 and/or consumer information database 117 (e.g., by transmitting the consumer concern to computing platform 110 with instructions to store the consumer concern).

Consumer information database 117 may store data that corresponds to each consumer computing device (e.g., consumer computing devices 130a-130f, or the like) that may initiate and/or execute transactions with enterprise organization computing device 140. Access to consumer information database 117 may differ depending on the computing device that is requesting access (e.g., a hierarchy of accessibility). Enterprise organization computing device 140 and consumer touch point orchestration module 111 may be associated with a first level of accessibility (e.g., a least restrictive level of accessibility). Enterprise organization computing device 140 and consumer touch point orchestration module 111 may perform functions on the data stored within consumer information database 117 (e.g., access the consumer data, add consumer data, remove consumer data, modify consumer data, or the like). The remaining computing devices within computing platform 110 may be associated with a second level of accessibility (e.g., a more restrictive level of accessibility than the first level of accessibility). The remaining computing devices within computing platform 110 may access the consumer data, but might not be permitted to add, remove, or modify the consumer data within consumer information database 117.

At step 209, enterprise organization computing device 140 may analyze the consumer concern to determine whether a unique consumer identifier, associated with consumer computing device 130, may be identified. Enterprise organization computing device 140 may use the unique consumer identifier to identify and track consumer computing devices that may be associated with the enterprise organization. If a consumer computing device is associated with the enterprise organization (e.g., initiates and/or executes transactions with the enterprise organization, or the like), then the consumer computing device may also be associated with a unique consumer identifier. Alternatively, if the consumer computing device is not associated with the enterprise organization (e.g., might not initiate and/or execute transactions with the enterprise organization, may initiate and/or execute transactions with a different enterprise organization, or the like), then the consumer computing device might not be associated with a unique consumer identifier.

Enterprise organization computing device 140 may identify personal identifiable information (e.g., a phone number, or the like) associated with consumer computing device 130 and may use the phone number to search consumer information database 117. If, at step 209, enterprise organization computing device 140 determines that the phone number associated with consumer computing device 130 might not correspond to data within consumer information database 117 (e.g., might not correspond to a unique consumer identifier, or the like), then, referring to FIG. 2C and at step 210a, enterprise organization computing device 140 may transmit, to consumer computing device 130, a request for additional personal identifiable information (e.g., a unique consumer identifier, a unique party identifier, at least one alternate phone number with which consumer computing device 130 may be associated, or the like) such that enterprise organization computing device 140 may identify a unique consumer identifier associated with consumer computing device 130.

At step 211, consumer computing device 130 may receive, from enterprise organization computing device 140, the request for personal identifiable information (e.g., a unique consumer identifier, a unique party identifier, at least one alternate phone number with which consumer computing device 130 may be associated, or the like). Consumer computing device 130 may transmit the requested personal identifiable information to enterprise organization computing device 140.

At step 212, enterprise organization computing device 140 may receive, from consumer computing device 130, a response to the request for additional personal identifiable information, wherein the request may comprise at least one of a unique consumerID, a unique partyID, at least one alternate phone number with which consumer computing device 130 may be associated, or the like. Enterprise organization computing device 140 may continue to parse the additional personal identifiable information to determine whether consumer information database 117 contains data that corresponds to consumer computing device 130. In some instances, enterprise organization computing device 140 may determine that the received personal identifiable information might not correspond to a unique consumer identifier. As such, enterprise organization computing device 140 may transmit, to consumer computing device, a notification indicating that the enterprise organization might not be able to process and/or resolve the consumer concern.

However, if, at step 209, enterprise organization computing device 140 determines that the phone number associated with consumer computing device 130 corresponds to data within consumer information database 117 (e.g., corresponds to a unique consumer identifier, or the like), then, at step 210b, enterprise organization computing device 140 may transmit, to consumer computing device 130, a request for a code that corresponds to the unique consumer identifier associated with consumer computing device 130 (e.g., a password, a personal identification number (PIN), or the like).

At step 213, consumer computing device 130 may receive, from enterprise organization computing device 140, the request for a code that corresponds to the unique consumer identifier associated with consumer computing device 130 (e.g., a password, a personal identification number (PIN), or the like). Consumer computing device 130 may transmit the requested code to enterprise organization computing device 140.

Referring to FIG. 2D, at step 214, enterprise organization computing device 140 may receive, from consumer computing device 130, a response to the request for the code that corresponds to the unique consumer identifier associated with consumer computing device 130, wherein the response may comprise the requested code. Enterprise organization computing device 140 may determine whether the code received from consumer computing device 130 corresponds to the unique consumer identifier associated with consumer computing device 130.

If, at step 214, enterprise organization computing device 140 determines that the received code might not correspond to the unique consumer identifier associated with consumer computing device 130, then, at step 215a, enterprise organization computing device 140 may transmit, to consumer computing device 130, a notification indicating that enterprise organization computing device 140 might not be able to process the consumer concern. The notification may further indicate at least one reason why enterprise organization computing device 140 might not be able to process the consumer concern (e.g., the consumer might not be associated with a unique consumer identifier, the code transmitted by consumer computing device 130 might not correspond to the unique consumer identifier, or the like). Alternatively, if, at step 214, enterprise organization computing device 140 determines that the received code corresponds to the unique consumer identifier associated with consumer computing device 130, then, at step 215b, enterprise organization computing device 140 may generate a token that corresponds to the consumer concern.

The token may contain information that describes consumer computing device 130 as well as the consumer concern that corresponds to consumer computing device 130. The token may comprise the personal identifiable information that corresponds to consumer computing device 130 (e.g., at least one phone number with which consumer computing device 130 may be associated, a unique consumer identifier, a password and/or PIN that corresponds to the unique consumer identifier, or the like). Additionally or alternatively, the token may comprise details that describe the consumer concern (e.g., a consumer intake number that corresponds to the consumer concern, a time that enterprise organization computing device 140 received the consumer concern, a date that enterprise organization computing device 140 received the consumer concern, at least one enterprise organization program and/or service to which the consumer concern may correspond, or the like). Enterprise organization computing device 140 may transmit the token to consumer computing device 130 and to consumer touch point orchestration module 111.

At step 216, consumer touch point orchestration module 111 may receive, from enterprise organization computing device 140, the token that may comprise the consumer concern as well as personal identifiable information that corresponds to consumer computing device 130. Consumer touch point orchestration module 111 may parse the token to extract the personal identifiable information and to identify consumer computing device 130.

Referring to FIG. 2E, at step 217, consumer touch point orchestration module 111 may parse consumer information database 117 to identify transactional issues that consumer computing device 130 may have experienced (e.g., transactional issues about which consumer computing device 130 may transmit, to enterprise organization computing device 140, a consumer concern, or the like).

At step 218, consumer touch point orchestration module 111 may parse the token to identify the transaction to which the consumer concern may correspond. Consumer touch point orchestration module 111 may parse consumer transactions database 116 and/or consumer information database 117 to determine whether either database contains information that corresponds to the transaction indicated in the consumer concern (e.g., whether at least one transaction within a transaction history associated with consumer computing device 130 corresponds to the transactional issue indicated in the consumer concern, or the like). If, at step 218, consumer touch point orchestration module 111 determines that neither one of consumer transactions database 116 nor consumer information database 117 contains information that corresponds to the transaction indicated in the consumer concern, then, at step 219a, consumer touch point orchestration module 111 may flag the consumer concern. Flagging the consumer concern may indicate that consumer touch point orchestration module 111 might not be able to predict the at least one transactional issue that consumer computing device 130 may have faced. Consumer touch point orchestration module 111 may, based on flagging the consumer concern, transmit a notification to enterprise organization computing device 140 indicating a request for manual intervention (e.g., a request for an agent to communicate with consumer computing device 130 to resolve the consumer concern, or the like).

Alternatively, if, at step 218, consumer touch point orchestration module 111 determines that at least one of consumer transactions database 116 or consumer information database 117 contains information that corresponds to the transaction indicated in the consumer concern, then, at step 219b, consumer touch point orchestration module 111 may parse the information (e.g., parse the description of the at least one transactional issue, parse whether the at least one transactional issue may have interrupted additional services and/or programs in which consumer computing device 130 may be interested, or the like).

Referring to FIG. 2F, at step 220, consumer touch point orchestration module 111 may further parse consumer transactions database 116 to determine whether the consumer concern may be similar to (e.g., match, be the same as, or the like) at least one previously received consumer concern. If, at step 220, consumer touch point orchestration module 111 determines that the consumer concern may be similar to at least one previously received consumer concern, then, at step 221a, consumer touch point orchestration module 111 may retrieve the at least one previously received consumer concern and at least one corresponding solution. Consumer touch point orchestration module 111 may parse the at least one solution that corresponds to the at least one previously received consumer concern. At step 222, consumer touch point orchestration module 111 may transmit, to consumer touch point aggregator module 112, the at least one previously received consumer concern, the corresponding solution, and the token.

However, if, at step 220, consumer touch point orchestration module 111 determines that the consumer concern might not be similar to previously received consumer concerns, then, referring to FIG. 2G and at step 221b, consumer touch point orchestration module 111 may generate at least one solution to the consumer concern. To do so, consumer touch point orchestration module 111 may parse enterprise organization programs database 118 to identify at least one enterprise organization service and/or program that may address (e.g., provide a solution for, provide alternatives around, or the like) the consumer concern.

Enterprise organization programs database 118 may contain a plurality of enterprise organization programs, services, promotions, or the like. Enterprise organization programs database 118 may also contain materials that describe each of the programs, services, and/or programs (e.g., informational and/or instructional material on available services and/or programs, informational material on ways to qualify for available services and/or programs, advice for selecting an available service and/or program, or the like). Access to enterprise organization programs database 118 may differ depending on the computing device that is requesting access (e.g., a hierarchy of accessibility). Enterprise organization computing device 140 and enterprise organization departmental modules 115a-115c may be associated with a first level of accessibility (e.g., a least restrictive level of accessibility). Enterprise organization computing device 140 and enterprise organization departmental modules 115a-115c may perform functions on the data stored within enterprise organization programs database 118 (e.g., access the available services and/or programs, add services and/or programs, remove services and/or programs, modify services and/or programs, or the like). The remaining computing devices within computing platform 110 may be associated with a second level of accessibility (e.g., a more restrictive level of accessibility than the first level of accessibility). The remaining computing devices within computing platform 110 may access the services and/or programs, but might not be permitted to add, remove, or modify the services and/or programs within enterprise organization programs database 118.

At step 223, consumer touch point orchestration module 111 may transmit the at least one service and/or program to consumer touch point aggregator module 112. In some instances, consumer touch point orchestration module 111 may determine that enterprise organization programs database 118 might not contain a service and/or program that may address the consumer concern. As such, consumer touch point orchestration module 111 may transmit a notification to enterprise organization computing device 140 indicating a request for manual intervention (e.g., a request for an enterprise organization agent to communicate with consumer computing device 130 to gather additional information and to resolve the consumer concern, or the like).

At step 224, consumer touch point aggregator module 112 may receive, from consumer touch point orchestration module 111, the consumer concern, the token that corresponds to the consumer concern, the at least one similar consumer concern, the at least one solution that corresponds to the at least one similar consumer concern, and/or at least one generated solution to the consumer concern (e.g., at least one enterprise organization service and/or program that may resolve the consumer concern, or the like). Consumer touch point aggregator module 112 may parse the received information and may identify an enterprise organization service to which the consumer concern may correspond (e.g., denial of service, application submission, loan request, or the like). Consumer touch points aggregator module 112 may use the parsed information to categorize the consumer concern. At step 225, consumer touch points aggregator module 112 may transmit the consumer concern and the consumer concern categorization to multifold solution generation engine 114.

Referring to FIG. 2H, at step 226, multifold solution generation engine 114 may receive the consumer concern from consumer touch point aggregator module 112. Multifold solution generation engine 114 may parse the consumer concern (e.g., identify keywords, identify key phrases, identify an enterprise organization service and/or program that consumer computing device 130 may have availed, or the like) to identify at least one enterprise organization department that may offer the service and/or program on which the consumer concern may be based. To do so, multifold solution generation engine 114 may parse enterprise organization programs database 118. Multifold solution generation engine 114 may compare the parsed consumer concern to the data within enterprise organization programs database 118 (e.g., compare keywords from the consumer concern to keywords that describe the services and/or programs, or the like). Multifold solution generation engine 114 may identify at least one service and/or program that may correspond to the consumer concern. Multifold solution generation engine 114 may identify an enterprise organization departmental module (e.g., at least one of enterprise organization departmental modules 115a-115c, or the like) that corresponds to the identified service and/or program.

At step 227, multifold solution generation engine 114 may transmit the consumer concern to the at least one enterprise organization departmental module. Each one of enterprise organization departmental modules 115a-115c may correspond to a different department within the enterprise organization (e.g., a consumer accounts department, a loan application department, a mortgage refinancing department, or the like).

At step 228, enterprise organization departmental module 115 may receive, from multifold solution generation engine 114, the consumer concern that may describe at least one transactional issue associated with at least one enterprise organization service and/or program offered by enterprise organization departmental module 115. Enterprise organization departmental module 115 may parse the received consumer concern to identify the at least one service and/or program upon which the consumer concern may be based. Enterprise organization departmental module 115 may analyze current procedures and/or protocols associated with the at least one service and/or program upon which the consumer concern may be based. In particular, enterprise organization departmental module 115 may identify potential areas for improvement within the current procedures and/or protocols (e.g., shortcomings within the current procedures and/or protocols that may have contributed to the at least one transactional issue indicated in the consumer concern, transactional issues that may have been experienced by a predetermined percentage of consumers, or the like).

Enterprise organization departmental module 115 may modify existing informational and/or instructional materials (e.g., pamphlets, campaigns, training materials, promotions, or the like) that correspond to the services and/or programs offered by enterprise organization departmental module 115. Additionally or alternatively, enterprise organization departmental module 115 may generate additional informational and/or instructional materials to clarify the identified areas for improvement. Enterprise organization departmental module 115 may use the additional and/or modified informational and/or instructional materials to modify and/or update current enterprise organization procedures and/or protocols. Enterprise organization departmental module 115 may also use the additional and/or modified informational and/or instructional materials to generate solutions to the at least one transactional issue indicated in the consumer concern.

At step 229, enterprise organization departmental module 115 may transmit the solutions and the modified and/or additional enterprise organization procedures and/or protocols to multifold solution generation engine 114. Enterprise organization departmental module 115 may also transmit, to multifold solution generation engine 114, instructions to transmit the modified and/or updated procedures and/or protocols to consumer computing devices that may have experienced transactional issues that correspond to the modified and/or updated procedures and/or protocols.

Referring to FIG. 2I, at step 230, multifold solution generation engine 114 may receive, from enterprise organization departmental module 115, the informational and/or instructional materials describing modifications and/or additions to enterprise organization services and/or programs (e.g., modifications and/or additions to enterprise organization services and/or programs based on an analysis of the at least one transactional issue indicated in the consumer concern, or the like). Multifold solution generation engine 114 may further receive at least one solution to the consumer concern from enterprise organization departmental module 115.

At step 231, consumer touch point aggregator module 112 may transmit, to consumer outlook generator module 113, the consumer concern, the token that corresponds to the consumer concern, and/or at least one solution to the consumer concern (e.g., at least one enterprise organization service and/or program indicated in enterprise organization programs database 118 that may address the transactional issue indicated in the consumer concern, modified and/or updated enterprise organization procedures and/or protocols that may address the transactional issue indicated in the consumer concern, at least one previously generated solution that may correspond to a previously received similar consumer concern, or the like).

At step 232, consumer outlook generator module 113 may receive, from consumer touch point aggregator module 112, the consumer concern, the token that corresponds to the consumer concern, and/or the at least one solution to the consumer concern. Consumer outlook generator module 113 may parse the received data to determine whether an agent from the enterprise organization may be needed to resolve the consumer concern. To determine whether an agent may be needed, consumer outlook generator module 113 may parse consumer transactions database 116 and/or consumer information database 117 to determine how the at least one solution was previously transmitted to consumers who submitted a similar consumer concern (e.g., whether the at least one solution was previously transmitted to consumer computing devices 130a-130f by an enterprise organization agent, by enterprise organization computing device 140, or the like). In some instances, consumer outlook generator module 113 may consider the generation and the complexity of the at least one solution to the consumer concern (e.g., solutions that might not have been previously transmitted to consumer computing devices 130a-130f may be transmitted through an agent, solutions that may require intervention from the enterprise organization may be transmitted through an agent, solutions that might not require further intervention from the enterprise organization may be transmitted through enterprise organization computing device 140, or the like).

If, at step 232, consumer outlook generator module 113 determines that an enterprise organization agent may be needed to resolve the consumer concern, then, at step 233a, consumer outlook generator module 113 may transmit the at least one solution and the token that corresponds to the consumer concern to an enterprise organization agent. To do so, consumer outlook generator module 113 may transmit, to enterprise organization computing device 140, instructions to submit the consumer concern, the corresponding token, and the at least one solution for manual intervention (e.g., submit to an enterprise organization agent, or the like). Alternatively, if, at step 232, consumer outlook generator module 113 determines that an agent might not be needed to resolve the consumer concern, then, referring to FIG. 2J and at step 233b, consumer outlook generator module 113 may transmit the at least one solution and the token that corresponds to the consumer concern to enterprise organization computing device 140.

At step 234, enterprise organization computing device 140 may receive, from consumer outlook generator module 113, the token that corresponds to the consumer concern and the at least one solution to the consumer concern. Enterprise organization computing device 140 may parse the received token to identify the consumer computing device (e.g., consumer computing device 130, or the like) to which the at least one solution should be transmitted. Enterprise organization computing device 140 may initiate communication with consumer computing device 130 (e.g., using the personal identifiable information indicated in the token, or the like). Enterprise organization computing device 140 may transmit the at least one solution to consumer computing device 130 using the previously initiated channel of communication.

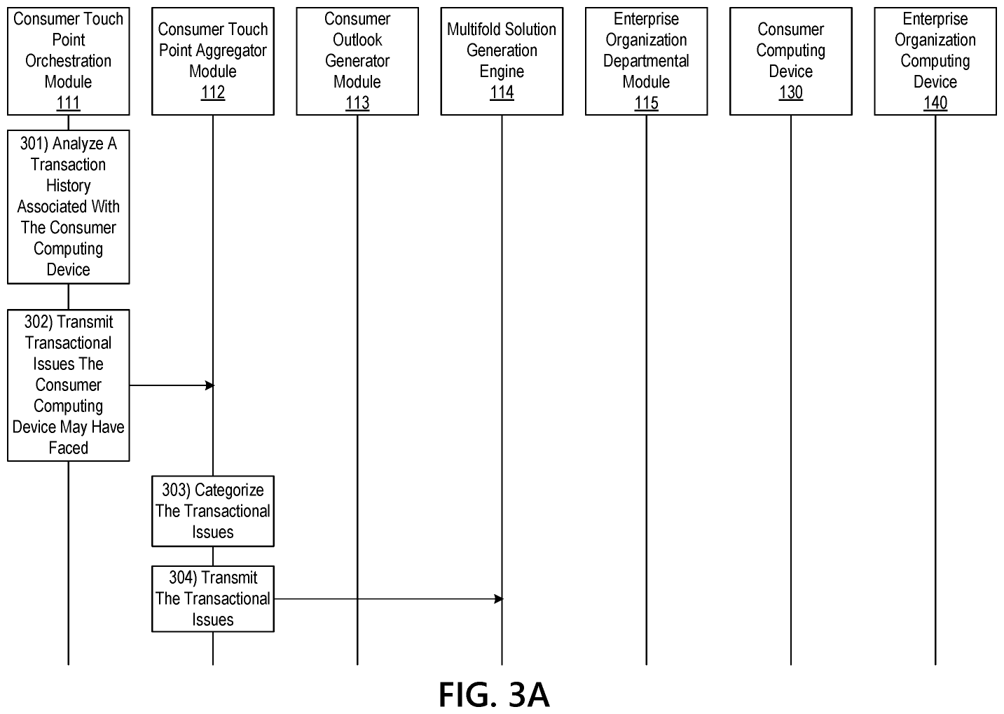

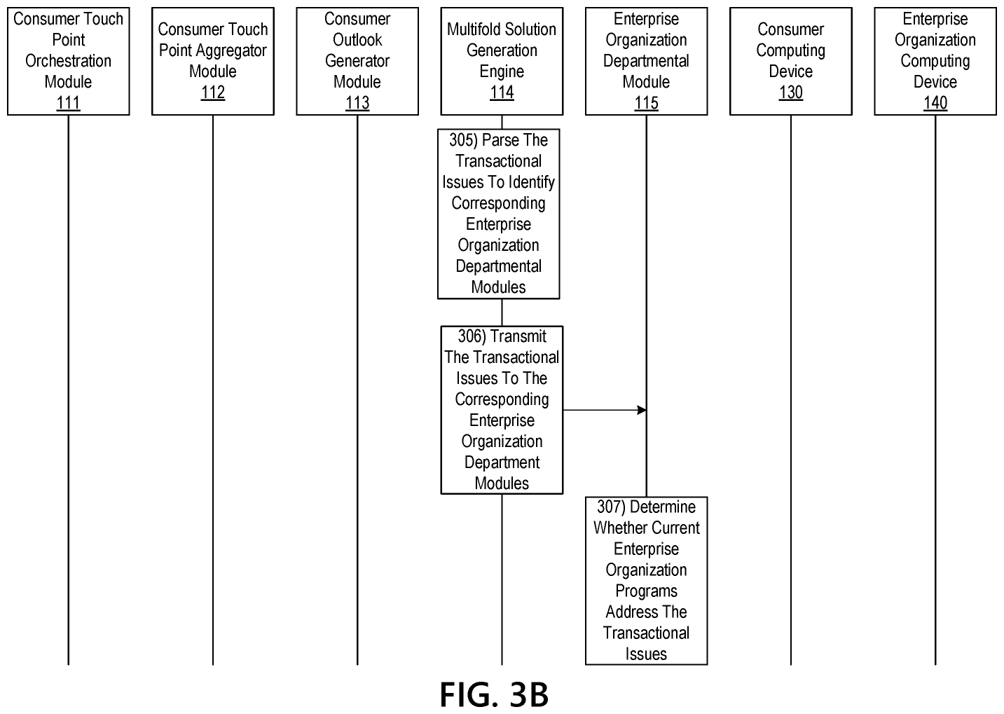

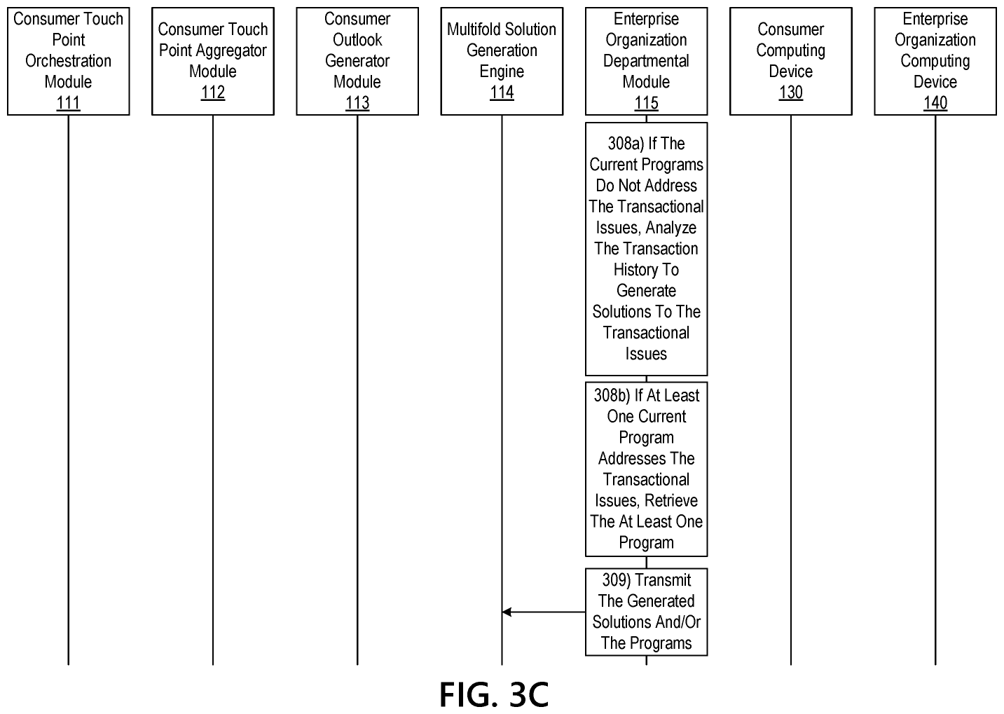

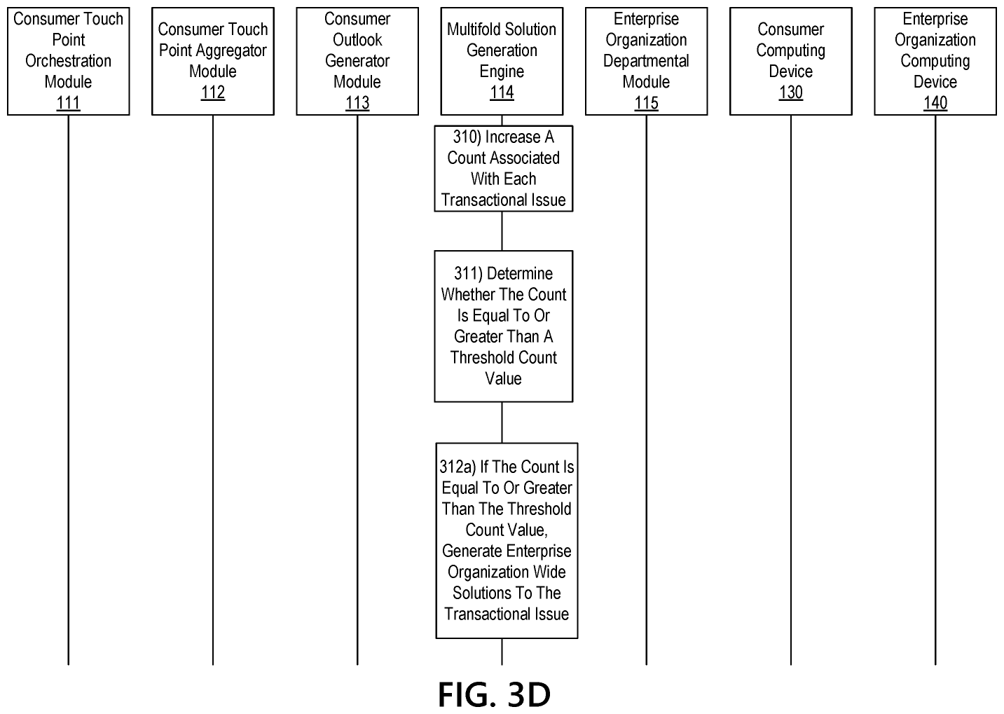

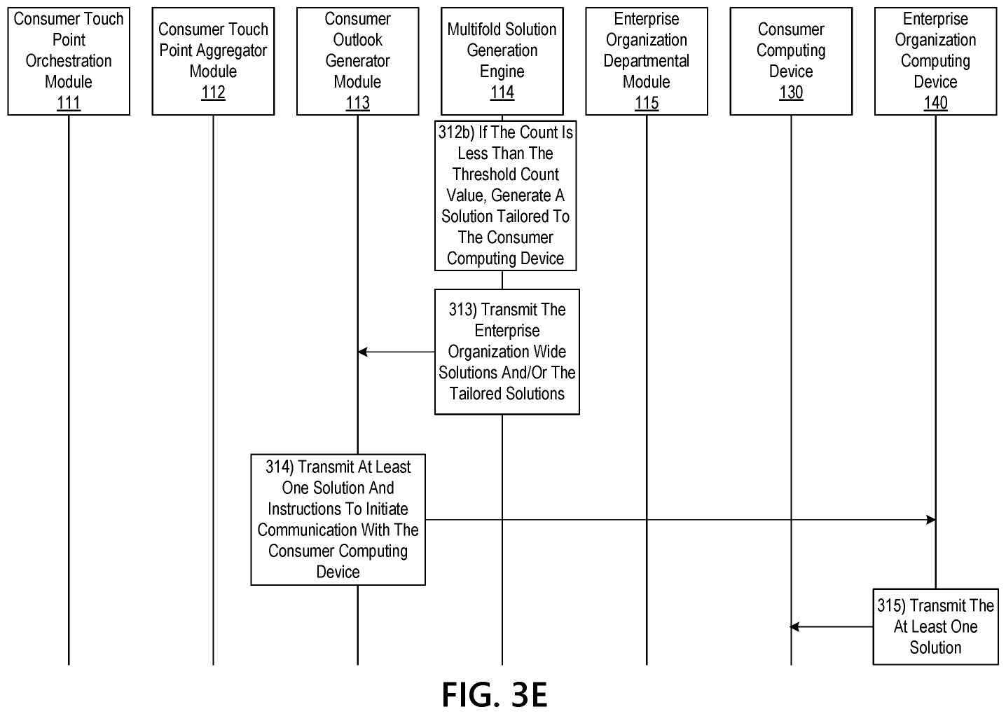

In some instances, computing platform 110 may be configured to continuously monitor consumer transactions and to preemptively generate and transmit, to consumer computing device 130, at least one solution to the at least one transactional issue that consumer computing device 130 may have experienced (e.g., in instances where consumer computing device 130 might not transmit, to enterprise organization computing device 140, a consumer concern indicating the at least one transactional issue, or the like). FIGS. 3A-3E depict an illustrative event sequence for generating, in real-time or near real-time, transaction recommendations based on monitoring and analyzing consumer transactions, in accordance with one or more aspects described herein. While aspects described with respect to FIGS. 3A-3E include the evaluation of a single transactional issue, a plurality transactional issues may be evaluated (e.g., in parallel) without departing from the present disclosure.

Referring to FIG. 3A, at step 301, consumer touch point orchestration module 111 may analyze (e.g., continuously, for a determined amount of time, at a determined time interval, or the like) each transaction within consumer transactions database 116 associated with consumer computing device 130. Consumer touch point orchestration module 111 may identify patterns within the transactions (e.g., a plurality of successful transactions, a plurality of unsuccessful transactions that may have been caused by at least one transactional issue, or the like) and/or outliers within the transactions (e.g., at least one transactional issue that consumer computing device 130 might not have previously experienced, or the like). Consumer touch point orchestration module 111 may predict an expected outcome for each transaction within consumer transactions database 116 that is associated with consumer computing device 130.

Consumer touch point orchestration module 111 may compare the expected outcome of each transaction to the identified patterns and/or outliers to determine whether consumer computing device 130 may have experienced at least one transactional issue. If consumer touch point orchestration module 111 determines that the expected outcome of the transaction corresponds to (e.g., matches, is similar to, is within a predetermined range of, or the like) the actual outcome that consumer computing device 130 may have experienced, then consumer touch point orchestration module 111 may determine that consumer computing device 130 might not have experienced a transactional issue. Alternatively, if consumer touch point orchestration module 111 determines that the expected outcome of the transaction might not correspond to (e.g., may be different from, might not be similar to, might not be within a predetermined range of, or the like) the actual outcome that consumer computing device 130 may have experienced, then consumer touch point orchestration module 111 may determine that consumer computing device 130 may have experienced a transactional issue.

Consumer information database 117 may contain details that describe consumer computing devices 130a-130f (e.g., previously transmitted consumer concerns, previously received solutions from enterprise organization computing device 140, enterprise organization services and/or programs that consumer computing device 130 may have availed, or the like). In some instances, consumer touch point orchestration module 111 may compare the data within consumer information database 117 to the identified patterns and/or outliers to identify transactional issues that consumer computing device 130 may have experienced.

At step 302, consumer touch point orchestration module 111 may transmit the identified transactional issues to consumer touch point aggregator module 112 for further processing. At step 303, consumer touch point aggregator module 112 may receive the transactional issues from consumer touch point orchestration module 111 and may categorize each identified transactional issue (e.g., denial of service at an enterprise organization terminal, rejection of a loan application, or the like). Additionally or alternatively, consumer touch point aggregator module 112 may analyze and categorize successful transactions to identify enterprise organization services and/or programs that may benefit consumer computing device 130 (e.g., services and/or programs that consumer computing device 130 may qualify for, services and/or programs that may help consumer computing device 130 achieve particular goals, or the like). At step 304, consumer touch point aggregator module 112 may transmit the identified transactional issues and/or the categorizations of the transactional issues to multifold solution generation engine 114.

Referring to FIG. 3B, at step 305, multifold solution generation engine 114 may receive the transactional issues and/or the categorizations of the transactional issues from consumer touch point aggregator module 112. Multifold solution generation engine 114 may parse the transactional issues (e.g., identify keywords, identify key phrases, identify an enterprise organization service and/or program with which consumer computing device 130 may have experienced the at least one transactional issue, or the like). To do so, multifold solution generation engine 114 may parse enterprise organization programs database 118. Multifold solution generation engine 114 may compare the parsed transactional issues to the data within enterprise organization programs database 118 (e.g., compare keywords from the transactional issues to keywords that describe the services and/or programs, or the like). Multifold solution generation engine 114 may identify at least one service and/or program with which consumer computing device 130 may have experienced the at least one transactional issue. Multifold solution generation engine 114 may identify an enterprise organization departmental module (e.g., at least one of enterprise organization departmental modules 115a-115c, or the like) that corresponds to the identified service and/or program.

At step 306, multifold solution generation engine 114 may transmit the at least one transactional issue to the enterprise organization departmental module (e.g., one of enterprise organization departmental modules 115a-115c, or the like) that may offer the service and/or program with which consumer computing device 130 may have experienced the at least one transactional issue. At step 307, enterprise organization departmental module 115 may receive the at least one transactional issue from multifold solution generation engine 114. For each transactional issue, enterprise organization departmental module 115 may determine whether at least one alternative enterprise organization program, service, and/or promotion offers a solution to the transactional issue (e.g., an enterprise organization program, service, and/or promotion that may be different from the enterprise organization program, service, and/or promotion with which consumer computing device 130 may have experienced the transactional issue, or the like). To do so, enterprise organization departmental module 115 may parse enterprise organization programs database 118. Enterprise organization departmental module 115 may identify features associated with each enterprise organization service and/or program within enterprise organization programs database 118. Enterprise organization departmental module 115 may compare each transactional issue to the identified features to determine whether at least one enterprise organization service and/or program addresses (e.g., comprises features that are relevant to, or the like) at least one transactional issue.

If, at step 307, enterprise organization departmental module 115 determines that enterprise organization programs database 118 might not contain alternative enterprise organization programs, services, and/or promotion that may offer a solution to the transactional issue, then, referring to FIG. 3C and at step 308a, enterprise organization departmental module 115 may generate additional enterprise organization procedures and/or protocols and/or may modify current enterprise organization procedures and/or protocols, as previously described. Enterprise organization departmental module 115 may analyze current procedures and/or protocols associated with the at least one service and/or program with which consumer computing device 130 may have experienced the transactional issue. In particular, enterprise organization departmental module 115 may identify potential areas for improvement within the current procedures and/or protocols (e.g., shortcomings within the current procedures and/or protocols that may have contributed to the at least one transactional issue, or the like).

Enterprise organization departmental module 115 may modify existing informational and/or instructional materials (e.g., pamphlets, campaigns, training materials, promotions, or the like) that correspond to the services and/or programs offered by enterprise organization departmental module 115. Additionally or alternatively, enterprise organization departmental module 115 may generate additional informational and/or instructional materials to clarify the identified areas for improvement. Enterprise organization departmental module 115 may use the additional and/or modified informational and/or instructional materials to modify and/or update current enterprise organization procedures and/or protocols. Enterprise organization departmental module 115 may also use the additional and/or modified informational and/or instructional materials to generate solutions to the at least one transactional issue indicated in the consumer concern.

Alternatively, if, at step 307, enterprise organization departmental module 115 determines that enterprise organization programs database 118 may contain at least one alternative enterprise organization program, service, and/or promotion that may offer a solution to the transactional issue, then, at step 308b, enterprise organization departmental module 115 may retrieve the at least one alternative enterprise organization program, service, and/or promotion from enterprise organization programs database 118. At step 309, enterprise organization departmental module 115 may transmit the generated and/or modified enterprise organization procedures and/or protocols to multifold solution generation engine 114. Enterprise organization departmental module 115 may also transmit the at least one alternative enterprise organization program, service, and/or promotion, retrieved from enterprise organization programs database 118, to multifold solution generation engine 114.

Referring to FIG. 3D, at step 310, multifold solution generation engine 114 may receive, from enterprise organization departmental module 115, the at least one transactional issue as well as the retrieved, generated, and/or modified enterprise organization procedures and/or protocols that may offer at least one solution to the at least one transactional issue. Multifold solution generation engine 114 may increase a count associated with each transactional issue. The count may indicate a number of times a consumer computing device (e.g., at least one of consumer computing devices 130a-103f, or the like) experienced the corresponding transactional issue. Multifold solution generation engine 114 may determine a threshold count value, wherein the threshold count value may indicate a minimum number of times the transactional issue may be experienced before an enterprise organization wide solution is generated to resolve the transactional issue.

At step 311, multifold solution generation engine 114 may determine whether the count associated with a transactional issue is less than, equal to, or greater than the threshold count value. If, at step 311, multifold solution generation engine 114 determines that the count associated with the transactional issue is equal to or greater than the threshold count value, then, at step 312a, multifold solution generation engine 114 may generate at least one enterprise organization wide solution to the transactional issue. To do so, multifold solution generation engine 114 may identify and extract variations within the transactional issue to generate a spectrum of transactional issues that consumer computing devices 130a-130f may have experienced (e.g., identify details that describe a first transactional issue that may be different from details that describe a second transactional issue, or the like). Multifold solution generation engine 114 may use the identified and extracted variations to determine features that the at least one enterprise organization wide solution should address. In some instances, multifold solution generation engine 114 may communicate with enterprise organization computing device 140 and/or an enterprise organization agent to generate at least one enterprise organization wide solution that addresses each variation.

Alternatively, if, at step 311, multifold solution generation engine 114 determines that the count associated with the transactional issue is less than the threshold count value, then, referring to FIG. 3E and at step 312b, multifold solution generation engine 114 may generate a solution that may be tailored to the consumer computing device that may have experienced the transactional issue (e.g., a solution tailored to consumer computing device 130 based on the transaction history associated with consumer computing device 130, a solution tailored to each one of consumer computing devices 130a-130f based on the variations within each transactional issue experienced by each of consumer computing devices 130a-130f, or the like). Multifold solution generation engine 114 may tailor a solution to consumer computing device 130 based on parsing consumer transactions database 116 and consumer information database 117 (e.g., based on identifying successful transactions, based on using features of the successful transactions to generate a tailored solution, or the like).

At step 313, multifold solution generation engine 114 may transmit the solutions (e.g., at least one solution tailored to at least one of consumer computing devices 130a-130f, at least one enterprise organization wide solution, or the like) to consumer outlook generator module 113. At step 314, consumer outlook generator module 113 may receive, from multifold solution generation engine 114, the at least one solution to the at least one transactional issue. Consumer outlook generator module 113 may transmit instructions to enterprise organization computing device 140 to initiate communication with consumer computing device 130. The instructions may indicate at least one method through which enterprise organization computing device 140 may communicate with consumer computing device 130. Consumer outlook generator module 113 may parse consumer information database 117 to identify at least one method of communication through which consumer computing device 130 may have previously received communication from enterprise organization computing device 140 and/or an enterprise organization agent (e.g., a phone number associated with consumer computing device 130, an email address associated with consumer computing device 130, a geographic address associated with consumer computing device 130, or the like).

At step 315, enterprise organization computing device 140 may receive, from consumer outlook generator module 113, instructions to initiate communication with consumer computing device 130. Enterprise organization computing device 140 may further receive, from consumer outlook generator module 113, at least one solution to the at least one transactional issue that consumer computing device 130 may have experienced. The instructions may comprise at least one method of communicating with consumer computing device 130 (e.g., a phone number that corresponds to consumer computing device 130, at email address that corresponds to consumer computing device 130, a street address that corresponds to consumer computing device 130, an enterprise organization portal through which consumer computing device 130 may receive messages from the enterprise organization, or the like). Enterprise organization computing device 140 may use the at least one method of communicating with consumer computing device 130 to transmit, to consumer computing device 130, the at least one solution to the at least one transactional issue that consumer computing device 130 may have experienced.

Enterprise organization computing device 140 may further transmit, to consumer computing device 130, a notification indicating that the at least one solution to the at least one transactional issue may be based on an analysis of the transaction history associated with consumer computing device 130. In some instances, the notification may comprise an indication and/or discussion of the transactions upon which the analysis may be based.

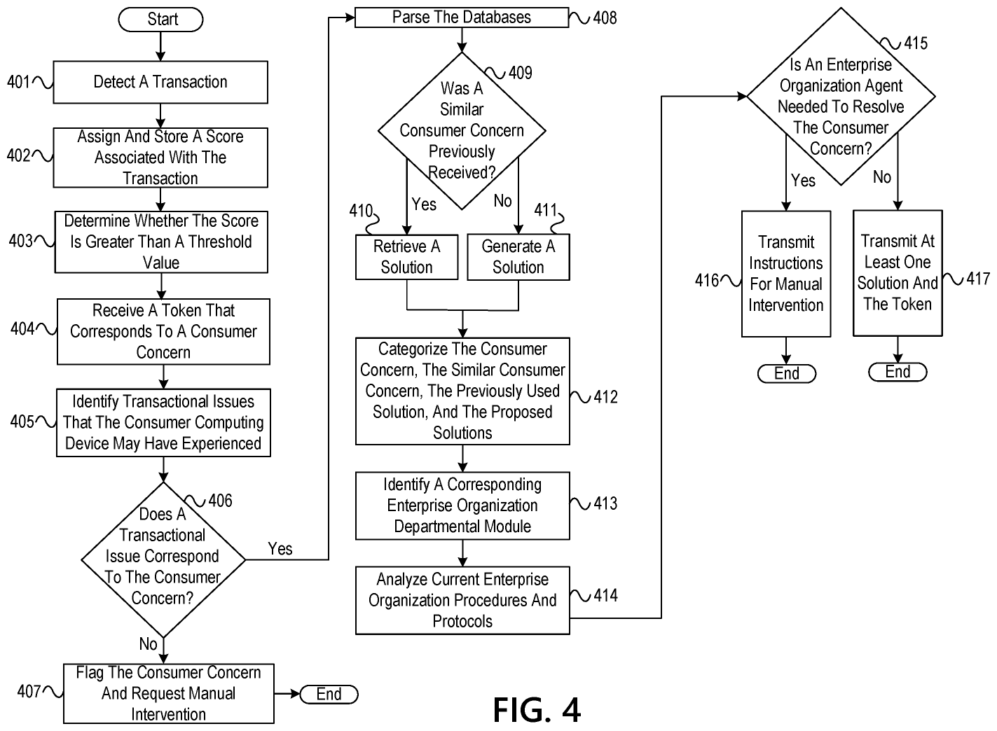

FIG. 4 depicts a flow diagram illustrating one example method for identifying and resolving, in real-time or near real-time, consumer transactions using consumer call analytics, in accordance with one or more aspects described herein. The processes illustrated in FIG. 4 are merely sample processes and functions. The steps shown may be performed in the order shown, in a different order, more steps may be added, or one or more steps may be omitted, without departing from the disclosure. In some examples, one or more steps may be performed simultaneously with other steps shown and described. Further, one or more steps described with respect to FIG. 4 may be performed in real-time or near real-time.

At step 401, consumer touch point orchestration module 111 may monitor interactions (e.g., consumer transactions, consumer requests to initiate a transaction, or the like) between consumer computing device 130 and/or the enterprise organization (e.g., enterprise organization computing device 140, or the like). Consumer touch point orchestration module 111 may detect a consumer transaction based on the monitoring. At step 402, consumer touch point orchestration module 111 may determine a score that corresponds to the transaction. To generate the score, consumer touch point orchestration module 111 may consider a plurality of factors (e.g., a transactional issue that consumer computing device 130 may have experienced, whether consumer computing device 130 may have previously experienced the transactional issue, whether the transactional issue may complicate additional enterprise organization services and/or programs in which consumer computing device 130 may be interested, or the like). Consumer touch point orchestration module 111 may assign a weight to each factor and may use the weighted factors to generate the score. Consumer touch point orchestration module 111 may store the transaction and the corresponding score within consumer transactions database 116.

At step 403, consumer touch point orchestration module 111 may determine whether the score that corresponds to each transaction is less than, equal to, or greater than the threshold value. If consumer touch point orchestration module 111 determines that the score that corresponds to a transaction is equal to or greater than the threshold value, then consumer touch point orchestration module 111 may determine that consumer computing device 130 may transmit a consumer concern containing a request for assistance with the corresponding transaction. Alternatively, if consumer touch point orchestration module 111 determines that the score that corresponds to the transaction is less than the threshold value, then consumer touch point orchestration module 111 may determine that consumer computing device 130 might not transmit a consumer concern containing a request for assistance with the corresponding transaction. In either instance, consumer touch point orchestration module 111 may store the determinations and may continue to analyze each transaction.

At step 404, consumer touch point orchestration module 111 may receive, from enterprise organization computing device 140, a token that may comprise a consumer concern as well as personal identifiable information that corresponds to consumer computing device 130. The consumer concern may identify and/or explain at least one transactional issue (e.g., unable to complete a deposit, unable to submit a loan application, unable to register for a mortgage repayment service, or the like) that consumer computing device 130 may have experienced. The token may contain information that describes consumer computing device 130 as well as the consumer concern. The token may comprise the personal identifiable information that corresponds to consumer computing device 130 (e.g., at least one phone number with which consumer computing device 130 may be associated, a unique consumer identifier, or the like). Additionally or alternatively, the token may comprise details that describe the consumer concern (e.g., a consumer intake number that corresponds to the consumer concern, a time that enterprise organization computing device 140 received the consumer concern, a date that enterprise organization computing device 140 received the consumer concern, at least one enterprise organization program and/or service to which the consumer concern may correspond, or the like).

At step 405, consumer touch point orchestration module 111 may parse consumer information database 117 to identify transactional issues that consumer computing device 130 may have experienced (e.g., transactional issues about which consumer computing device 130 may transmit, to enterprise organization computing device 140, a consumer concern, or the like).

At step 406, consumer touch point orchestration module 111 may parse the token to identify the transaction to which the consumer concern may correspond. Consumer touch point orchestration module 111 may parse consumer transactions database 116 and/or consumer information database 117 to determine whether either database contains information that corresponds to the transaction indicated in the consumer concern. If, at step 406, consumer touch point orchestration module 111 determines that neither one of consumer transactions database 116 nor consumer information database 117 contains information that corresponds to the transaction indicated in the consumer concern, then, at step 407, consumer touch point orchestration module 111 may flag the consumer concern and may transmit a notification to enterprise organization computing device 140 indicating a request for manual intervention (e.g., a request for an agent to communicate with consumer computing device 130 to resolve the consumer concern, or the like). Alternatively, if, at step 406, consumer touch point orchestration module 111 determines that at least one of consumer transactions database 116 or consumer information database 117 contains information that corresponds to the transaction indicated in the consumer concern, then, at step 408, consumer touch point orchestration module 111 may parse the information.

At step 409, consumer touch point orchestration module 111 may further parse consumer transactions database 116 to determine whether the consumer concern may be similar to (e.g., match, be the same as, or the like) at least one previously received consumer concern. If, at step 409, consumer touch point orchestration module 111 determines that the consumer concern may be similar to at least one previously received consumer concern, then, at step 410, consumer touch point orchestration module 111 may retrieve the at least one previously received consumer concern and at least one corresponding solution. However, if, at step 409, consumer touch point orchestration module 111 determines that the consumer concern might not be similar to previously received consumer concerns, then, at step 411, consumer touch point orchestration module 111 may generate at least one solution to the consumer concern.

At step 412, consumer touch point aggregator module 112 may parse the consumer concern, the token that corresponds to the consumer concern, the at least one similar consumer concern, the at least one solution that corresponds to the at least one similar consumer concern, and/or at least one generated solution to the consumer concern. Consumer touch points aggregator module 112 may use the parsed information to categorize the consumer concern based on an enterprise organization service to which the consumer concern may correspond (e.g., denial of service, application submission, loan request, or the like).

At step 413, multifold solution generation engine 114 may parse the consumer concern (e.g., identify keywords, identify key phrases, identify an enterprise organization service and/or program that consumer computing device 130 may have availed, or the like) to identify at least one enterprise organization department that may offer the service and/or program on which the consumer concern may be based. Multifold solution generation engine 114 may parse enterprise organization programs database 118. Multifold solution generation engine 114 may compare the parsed consumer concern to the data within enterprise organization programs database 118 to identify at least one service and/or program that may correspond to the consumer concern. Multifold solution generation engine 114 may identify an enterprise organization departmental module (e.g., at least one of enterprise organization departmental modules 115a-115c, or the like) that corresponds to the identified service and/or program.

At step 414, enterprise organization departmental module 115 may parse the consumer concern to identify the at least one service and/or program upon which the consumer concern may be based. Enterprise organization departmental module 115 may analyze current procedures and/or protocols associated with the at least one service and/or program upon which the consumer concern may be based. Enterprise organization departmental module 115 may, based on the analysis, identify potential areas for improvement within the current procedures and/or protocols. Enterprise organization departmental module 115 may modify existing informational and/or instructional materials (e.g., pamphlets, campaigns, training materials, promotions, or the like) that correspond to the services and/or programs offered by enterprise organization departmental module 115. Additionally or alternatively, enterprise organization departmental module 115 may generate additional informational and/or instructional materials to clarify the identified areas for improvement. Enterprise organization departmental module 115 may use the additional and/or modified informational and/or instructional materials to modify and/or update current enterprise organization procedures and/or protocols. Enterprise organization departmental module 115 may also use the additional and/or modified informational and/or instructional materials to generate solutions to the at least one transactional issue indicated in the consumer concern.

At step 415, consumer outlook generator module 113 may determine whether an enterprise organization agent may be needed to resolve the consumer concern. Consumer outlook generator module 113 may parse consumer transactions database 116 and/or consumer information database 117 to determine how the at least one solution was previously transmitted to consumers who submitted a similar consumer concern (e.g., whether the at least one solution was previously transmitted to consumer computing devices 130a-130f by an enterprise organization agent, by enterprise organization computing device 140, or the like).

If, at step 415, consumer outlook generator module 113 determines that an agent associated with the enterprise organization may be needed to resolve the consumer concern, then, at step 416, consumer outlook generator module 113 may transmit the at least one solution and the token that corresponds to the consumer concern to an enterprise organization agent. Consumer outlook generator module 113 may transmit, to enterprise organization computing device 140, instructions to submit the consumer concern, the corresponding token, and the at least one solution for manual intervention (e.g., submit to an enterprise organization agent, or the like). However, if, at step 415, consumer outlook generator module 113 determines that an agent might not be needed to resolve the consumer concern, then, at step 417, consumer outlook generator module 113 may transmit the at least one solution and the token that corresponds to the consumer concern to enterprise organization computing device 140. Consumer outlook generator module 113 may further transmit, to enterprise organization computing device 140, instructions to initiate communication with consumer computing device 130 and instructions to transmit that at least one solution to consumer computing device 130.

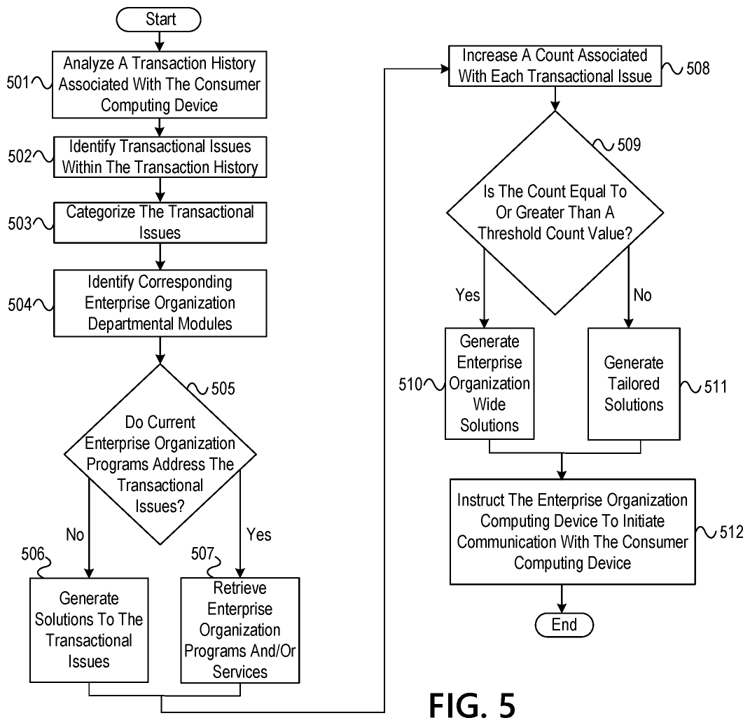

FIG. 5 depicts a flow diagram illustrating one example method for generating, in real-time or near real-time, transaction recommendations based on monitoring and analyzing consumer transactions, in accordance with one or more aspects described herein. The processes illustrated in FIG. 5 are merely sample processes and functions. The steps shown may be performed in the order shown, in a different order, more steps may be added, or one or more steps may be omitted, without departing from the disclosure. In some examples, one or more steps may be performed simultaneously with other steps shown and described. Further, one or more steps described with respect to FIG. 5 may be performed in real-time or near real-time.

Referring to FIG. 5, at step 501, consumer touch point orchestration module 111 may analyze (e.g., continuously, for a determined amount of time, at a determined time interval, or the like) each transaction associated with consumer computing device 130.

At step 502, consumer touch point orchestration module 111 may identify patterns within the transaction history (e.g., a plurality of successful transactions, a plurality of unsuccessful transactions that may have been caused by at least one transactional issue, or the like) and/or outliers within the transaction history (e.g., at least one transactional issue that consumer computing device 130 might not have previously experienced, or the like). Consumer touch point orchestration module 111 may predict an expected outcome for each transaction. Consumer touch point orchestration module 111 may compare the expected outcome of each transaction to the identified patterns and/or outliers to determine whether consumer computing device 130 may have experienced at least one transactional issue. If consumer touch point orchestration module 111 determines that the expected outcome of the transaction corresponds to the actual outcome that consumer computing device 130 may have experienced, then consumer touch point orchestration module 111 may determine that consumer computing device 130 might not have experienced a transactional issue. Alternatively, if consumer touch point orchestration module 111 determines that the expected outcome of the transaction might not correspond to (e.g., may be different from, might not be similar to, might not be within a predetermined range of, or the like) the actual outcome that consumer computing device 130 may have experienced, then consumer touch point orchestration module 111 may determine that consumer computing device 130 may have experienced a transactional issue.

At step 503, consumer touch points aggregator module 112 may categorize each identified transactional issue (e.g., denial of service, application submission, loan request, or the like).

At step 504, multifold solution generation engine 114 may parse the transactional issues to identify at least one service and/or program with which consumer computing device 130 may have experienced the at least one transactional issue. Multifold solution generation engine 114 may identify an enterprise organization departmental module (e.g., at least one of enterprise organization departmental modules 115a-115c, or the like) that corresponds to the identified service and/or program.

At step 505, enterprise organization departmental module 115 may determine whether at least one alternative enterprise organization program, service, and/or promotion offers a solution to the transactional issue (e.g., an enterprise organization program, service, and/or promotion that may be different from the enterprise organization program, service, and/or promotion with which consumer computing device 130 may have experienced the transactional issue, or the like).

If, at step 505, enterprise organization departmental module 115 determines that enterprise organization programs database 118 might not contain alternative enterprise organization programs, services, and/or promotion that may offer a solution to the transactional issue, then, at step 506, enterprise organization departmental module 115 may generate additional enterprise organization procedures and/or protocols and/or may modify current enterprise organization procedures and/or protocols. Enterprise organization departmental module 115 may use the additional and/or modified informational and/or instructional materials to modify and/or update current enterprise organization procedures and/or protocols. Enterprise organization departmental module 115 may also use the additional and/or modified informational and/or instructional materials to generate solutions to the at least one transactional issue indicated in the consumer concern.

Alternatively, if at step 505, enterprise organization departmental module 115 determines that enterprise organization programs database 118 may contain at least one alternative enterprise organization program, service, and/or promotion that may offer a solution to the transactional issue, then, at step 507, enterprise organization departmental module 115 may retrieve the at least one alternative enterprise organization program, service, and/or promotion from enterprise organization programs database 118.

At step 508, multifold solution generation engine 114 may increase a count associated with each transactional issue. The count may indicate a number of times a consumer computing device (e.g., at least one of consumer computing devices 130a-103f, or the like) experienced the corresponding transactional issue. Multifold solution generation engine 114 may determine a threshold count value, wherein the threshold count value may indicate a minimum number of times the transactional issue may be experienced before an enterprise organization wide solution is generated to resolve the transactional issue.

At step 509, multifold solution generation engine 114 may determine whether the count associated with a transactional issue is less than, equal to, or greater than the threshold count value.

If, at step 509, multifold solution generation engine 114 determines that the count associated with the transactional issue is equal to or greater than the threshold count value, then, at step 510, multifold solution generation engine 114 may generate at least one enterprise organization wide solution to the transactional issue. Alternatively, if at step 509, multifold solution generation engine 114 determines that the count associated with the transactional issue is less than the threshold count value, then, at step 511, multifold solution generation engine 114 may generate a solution that may be tailored to the consumer computing device that may have experienced the transactional issue (e.g., a solution tailored to consumer computing device 130 based on the transaction history associated with consumer computing device 130, a solution tailored to each one of consumer computing devices 130a-130f based on the variations within each transactional issue experienced by each of consumer computing devices 130a-130f, or the like).

At step 512, consumer outlook generator module 113 may transmit instructions to enterprise organization computing device 140 to initiate communication with consumer computing device 130. The instructions may indicate at least one method through which enterprise organization computing device 140 may communicate with consumer computing device 130. The instructions may comprise at least one solution to the at least one transactional issue that consumer computing device 130 may have experienced. Consumer outlook generator module 113 may instruct enterprise organization computing device 140 to transmit the at least one solution to the at least one transactional issue to consumer computing device 130.

As a result, the proposed solution may provide the following benefits: 1) real-time, or near real-time, monitoring of consumer transactions with an enterprise organization; 2) real time, or near real time, analysis of the consumer transactions; 3) real time, or near real time, generation of at least one enterprise organization wide solution to at least one transactional issue; and 4) real time, or near real time, generation of at least one solution to the at least one transactional issue, which may be tailored to the consumer and may be based on a consumer transaction history.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an enterprise computing platform, or as one or more non-transitory computer-readable media storing instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space).

As described herein, the various methods and acts may be operative across one or more computing servers and one or more networks. The functionality may be distributed in any manner, or may be located in a single computing device (e.g., a server, a user computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method comprising:
at a computing device including one or more processors and memory:
detecting a plurality of transactions between a consumer computing device and an enterprise organization computing device;
storing the plurality of transactions in a transaction history associated with the consumer computing device;
assigning a score to each transaction of the plurality of transactions;
receiving, from the consumer computing device, a consumer concern requesting assistance with a transaction;
receiving, from the enterprise organization computing device, a token comprising details that describe the consumer concern and the consumer computing device;
determining whether the consumer concern corresponds to at least one transaction within the transaction history associated with the consumer computing device;
based on determining the consumer concern corresponds to at least one transaction within the transaction history, determining whether the transaction is similar to at least one previously received transaction;
based on determining the transaction is different from previously received transactions, generating a solution to the consumer concern; and
transmitting, to the enterprise organization computing device, instructions to initiate communication with the consumer computing device to resolve the consumer concern.

2. The method of claim 1, wherein the assigning the score to each transaction of the plurality of transactions further comprises predicting, for each transaction, a likelihood that consumer computing device will request assistance with the transaction.

3. The method of claim 2, wherein the score assigned to a transaction, of the plurality of transactions, is within one of:
a first level of likelihood, wherein the score within the first level of likelihood indicates the consumer computing device will request assistance with the transaction; or
a second level of likelihood, wherein the score within the second level of likelihood indicates the consumer computing device will not request assistance with the transaction.

4. The method of claim 1, further comprising:
generating the token, wherein the generating comprises determining whether the consumer computing device corresponds to a unique consumer identifier, and wherein the token is used to:
transmit the details that describe the consumer concern and the consumer computing device; and
confirm receipt of the consumer concern.

5. The method of claim 4, further comprising, based on determining the consumer computing device does not correspond to the unique consumer identifier, requesting personal identifiable information from the consumer computing device, wherein the personal identifiable information comprises at least one of:
a phone number that is registered with the enterprise organization and is associated with the consumer computing device;
the unique consumer identifier that is registered with the enterprise organization and is associated with the consumer computing device; or
a unique party identification number that is registered with the enterprise organization and is associated with the consumer computing device.

6. The method of claim 4, further comprising, based on determining the consumer computing device corresponds to the unique consumer identifier, requesting, from the consumer computing device, a code that corresponds to the unique consumer identifier, wherein the code comprises at least one of:
a password that corresponds to the unique consumer identifier; or
a personal identification number (PIN) that corresponds to the unique consumer identifier.

7. The method of claim 6, further comprising one of:
based on determining the code fails to correspond to the unique consumer identifier, transmitting, to the consumer computing device, a notification indicating the consumer concern cannot be processed; or
based on determining the code corresponds to the unique consumer identifier, transmitting the token to the consumer computing device.

8. The method of claim 1, wherein the details that describe the consumer concern may consist of at least one of:
a transactional issue that the consumer computing device experienced;
an enterprise organization service with which the consumer computing device experienced the transactional issue; or
an enterprise organization program within which the consumer computing device experienced the transactional issue.

9. The method of claim 1, wherein the details that describe the consumer computing device consist of at least one of:
a phone number that corresponds to the consumer computing device; or
a unique consumer identifier that corresponds to the consumer computing device.

10. The method of claim 1, further comprising, based on determining the consumer concern does not correspond to transactions within the transaction history, requesting, from the consumer computing device, details that describe at least one transactional issue that consumer computing device experienced.

11. The method of claim 1, further comprising, based on determining the transaction is not similar to the at least one previously received transaction, generating a solution to the consumer concern.

12. The method of claim 11, wherein the generating the solution to the consumer concern comprises identifying, from a plurality of enterprise organization programs and services, at least one enterprise organization program or at least one enterprise organization service that addresses at least one transactional issue indicated in the consumer concern.

13. The method of claim 11, wherein the generating the solution to the consumer concern comprises:
identifying at least one of:
an enterprise organization department that offers at least one enterprise organization service with which the consumer computing device experienced a transaction issue; or
an enterprise organization department that offers at least one enterprise organization program within which the consumer computing device experienced the transactional issue;
parsing enterprise organization procedures and protocols that correspond to the enterprise organization department;
determining, based on the parsing, whether the enterprise organization procedures and protocols resolve at least one transactional issue indicated in the consumer concern; and
based on determining the enterprise organization procedures and protocols resolve the at least one transactional issue indicated in the consumer concern, transmitting the enterprise organization procedures and protocols to the consumer computing device.

14. The method of claim 13, further comprising, based on determining the enterprise organization procedures and protocols do not resolve the at least one transactional issue indicated in the consumer concern, modifying the enterprise organization procedures and protocols to address the at least one transactional issue.

15. The method of claim 1, further comprising, based on determining the transaction is similar to the at least one previously received transaction:
identifying at least one solution that corresponds to the at least one previously received transaction;
analyzing the at least one previously received transaction and the at least one solution that corresponds to the at least one previously received transaction; and
transmitting the at least one solution that corresponds to the at least one previously received transaction to the consumer computing device.

16. The method of claim 1, wherein the receiving the consumer concern comprises receiving, by the enterprise organization computing device, a phone call from the consumer computing device.

17. A computing platform comprising:
at least one processor;
a communication interface communicatively coupled to the at least one processor; and
memory storing computer-readable instructions that, when executed by the at least one processor, cause the computing platform to:
detect a plurality of transactions between a consumer computing device and an enterprise organization computing device;
store the plurality of transactions in a transaction history associated with the consumer computing device;
assign a score to each transaction of the plurality of transactions;
receive, from the consumer computing device, a consumer concern requesting assistance with a transaction;
receive, from the enterprise organization computing device, a token comprising details that describe the consumer concern and the consumer computing device;
determine whether the consumer concern corresponds to at least one transaction within the transaction history associated with the consumer computing device;
based on determining the consumer concern corresponds to at least one transaction within the transaction history, determine whether the transaction is similar to at least one previously received transaction;
based on determining the transaction is different from previously received transactions, generate a solution to the consumer concern; and
transmit, to the enterprise organization computing device, instructions to initiate communication with the consumer computing device to resolve the consumer concern.

18. The computing platform of claim 17, wherein the receiving the consumer concern further causes the computing platform to receive, by the enterprise organization computing device, a phone call from the consumer computing device.

19. One or more non-transitory computer-readable media storing instructions that, when executed by a computing platform comprising at least one processor, memory, and a communication interface, cause the computing platform to:
detect a plurality of transactions between a consumer computing device and an enterprise organization computing device;
store the plurality of transactions in a transaction history associated with the consumer computing device;
assign a score to each transaction of the plurality of transactions;
receive, from the consumer computing device, a consumer concern requesting assistance with a transaction;
receive, from the enterprise organization computing device, a token comprising details that describe the consumer concern and the consumer computing device;
determine whether the consumer concern corresponds to at least one transaction within the transaction history associated with the consumer computing device;
based on determining the consumer concern corresponds to at least one transaction within the transaction history, determine whether the transaction is similar to at least one previously received transaction;
based on determining the transaction is different from previously received transactions, generate a solution to the consumer concern; and
transmit, to the enterprise organization computing device, instructions to initiate communication with the consumer computing device to resolve the consumer concern.

20. The non-transitory computer-readable media of claim 19, wherein the receiving the consumer concern further causes the computing platform to receive, by the enterprise organization computing device, a phone call from the consumer computing device.
